(19) United States
(12) Patent Application Publication
(10) Pub. No.: US 2026/0046059 A1
(43) Pub. Date: Feb. 12, 2026

(54) METHOD AND APPARATUS FOR SYNCHRONIZATION

(71) Applicant: Samsung Electronics Co., Ltd., Suwon-si (KR)

(72) Inventors: Hyunseob OH, Suwon-si (KR); Kisoo AN, Suwon-si (KR); Junha PARK, Suwon-si (KR)

(21) Appl. No.: 19/293,563

(22) Filed: Aug. 7, 2025

(30) Foreign Application Priority Data
Aug. 8, 2024 (KR) 10-2024-0106153

(51) Int. Cl. H04L 1/00

(52) U.S. Cl. CPC H04L 1/0003

(57) ABSTRACT

A method and a device for synchronization are provided. A method of a first device is provided. The method includes transmitting a first message related to calculation of a first offset for synchronization with a second device, transmitting a second message including information regarding a timepoint at which the first message was transmitted from the first device, receiving a third message related to calculation of a second offset for synchronization with the second device, and transmitting a fourth message including information regarding a timepoint at which the third message was received by the first device. With regard to the first message and the third message, an MCS configuration corresponding to one fixed modulation and coding scheme (MCS) index among available candidate MCS index values is applied, or one MCS configuration within an MCS subset configured by MCS configurations corresponding to at least one MCS index equal to or lower than an MCS index among the available candidate MCS index values is applied, and the highest priority among priorities related to securing transmission opportunities is applied.

### CROSS-REFERENCE TO RELATED APPLICATION(S)

This application is based on and claims priority under 35 U.S.C. § 119(a) of a Korean patent application number 10-2024-0106153, filed on Aug. 8, 2024, in the Korean Intellectual Property Office, the disclosure of which is incorporated by reference herein in its entirety.

### BACKGROUND

### 1. Field

The disclosure relates to a method and an apparatus for synchronization.

### 2. Description of Related Art

Synchronization between devices in a Wi-Fi system is an important technical challenge for providing a high-quality multimedia experience.

Synchronization between devices may be implemented by using packet structures. For example, a specific form of packet structure may be used to synchronize video data and sensor data (including audio). This packet includes both video and audio data, allowing the receiving device to reproduce the data with accurate timing.

In addition, synchronization between devices may be implemented by utilizing timestamps. For example, timestamps may be assigned to audio and video frames such that accurate time information is delivered. This may enable the receiving device to reproduce each frame at the precise timepoint.

In addition, synchronization between devices may be implemented through clock synchronization. The audio clocks may be synchronized between the transmitter and the receiver, thereby minimizing the time difference.

In addition, appropriate buffering techniques may be used to resolve issues caused by network delays or packet losses, thereby ensuring synchronization while maintaining the continuity of audio and video streams.

By combining and using such various synchronization schemes as described above, effective synchronization between video and audio data may be achieved in a Wi-Fi system, and users may be provided with a high-quality multimedia experience.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and an apparatus for synchronization.

Additional aspects will be set forth in part in the description which follows and, in part, will be apparent from the description, or may be learned by practice of the presented embodiments.

In accordance with an aspect of the disclosure, a method of a first device is provided. The method includes transmitting a first message related to calculation of a first offset for synchronization with a second device, transmitting a second message including information regarding a timepoint at which the first message was transmitted from the first device, receiving a third message related to calculation of a second offset for synchronization with the second device, and transmitting a fourth message including information regarding a timepoint at which the third message was received by the first device, wherein, with regard to the first message and the third message, an MCS configuration corresponding to one fixed modulation and coding scheme (MCS) index among available candidate MCS index values is applied, or one MCS configuration within an MCS subset configured by MCS configurations corresponding to at least one MCS index equal to or lower than an MCS index among the available candidate MCS index values is applied, and the highest priority among priorities related to securing transmission opportunities is applied.

In accordance with another aspect of the disclosure, a method of a second device is provided. The method includes receiving a first message related to calculation of a first offset for synchronization with a first device, receiving a second message including information regarding a timepoint at which the first message was transmitted from the first device, transmitting a third message related to calculation of a second offset for synchronization with the first device, and receiving a fourth message including information regarding a timepoint at which the third message was received by the first device, wherein, with regard to the first message and the third message, an MCS configuration corresponding to one fixed modulation and coding scheme (MCS) index among available candidate MCS index values is applied, or one MCS configuration within an MCS subset configured by MCS configurations corresponding to at least one MCS index equal to or lower than an MCS index among the available candidate MCS index values is applied, and the highest priority among priorities related to securing transmission opportunities is applied.

In accordance with another aspect of the disclosure, a first device is provided. The first device includes a transceiver and a controller coupled with the transceiver, wherein the controller is configured to transmit a first message related to calculation of a first offset for synchronization with a second device, transmit a second message including information regarding a timepoint at which the first message was transmitted from the first device, receive a third message related to calculation of a second offset for synchronization with the second device, and transmit a fourth message including information regarding a timepoint at which the third message was received by the first device, wherein, with regard to the first message and the third message, an MCS configuration corresponding to one fixed modulation and coding scheme (MCS) index among available candidate MCS index values is applied, or one MCS configuration within an MCS subset configured by MCS configurations corresponding to at least one MCS index equal to or lower than an MCS index among the available candidate MCS index values is applied, and the highest priority among priorities related to securing transmission opportunities is applied.

In accordance with another aspect of the disclosure, a second device is provided. The second device includes a transceiver and a controller coupled with the transceiver, wherein the controller is configured to receive a first message related to calculation of a first offset for synchronization with a first device, receive a second message including information regarding a timepoint at which the first message was transmitted from the first device, transmit a third message related to calculation of a second offset for synchronization with the first device, and receive a fourth message including information regarding a timepoint at which the third message was received by the first device, wherein, with regard to the first message and the third message, an MCS configuration corresponding to one fixed modulation and coding scheme (MCS) index among available candidate MCS index values is applied, or one MCS configuration within an MCS subset configured by MCS configurations corresponding to at least one MCS index equal to or lower than an MCS index among the available candidate MCS index values is applied, and the highest priority among priorities related to securing transmission opportunities is applied.

An embodiment of the disclosure is advantageous in that, when performing synchronization between devices, the occurrence of errors due to message transmission delays is prevented.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram of an electronic device according to an embodiment of the disclosure;

FIG. 3 is a diagram illustrating a system to which a synchronization method may be applied according to an embodiment of the disclosure;

FIG. 4 is a diagram illustrating a system to which a synchronization method may be applied according to an embodiment of the disclosure;

FIG. 5 is a flowchart illustrating a procedure in which a synchronization method is performed according to an embodiment of the disclosure;

FIG. 6 is a diagram illustrating problems of a software (SW)-based precision timing protocol (PTP) procedure according to an embodiment of the disclosure;

FIG. 7 is a flowchart illustrating a hardware (HW)-based PTP procedure according to an embodiment of the disclosure;

FIG. 8 is a diagram illustrating a case where an error occurs while performing a PTP procedure due to delay caused by failed transmission opportunity acquisition and retransmission according to an embodiment of the disclosure;

FIG. 9 is a diagram illustrating a case where an error occurs while performing a PTP procedure due to delay caused by failed transmission opportunity acquisition and retransmission according to an embodiment of the disclosure;

FIG. 10 is a diagram a scheme for improving an occurrence of errors due to delays caused by retransmission of PTP procedure-related messages according to an embodiment of the disclosure;

FIG. 11 is a diagram illustrating a request to send/clear to send (RTS/CTS) procedure is performed according to an embodiment of the disclosure;

FIG. 12 is a flowchart illustrating performing a PTP procedure to which schemes for improving errors are applied according to an embodiment of the disclosure;

FIG. 13 is a flowchart illustrating performing a PTP procedure to which schemes for improving errors are applied according to an embodiment of the disclosure;

FIG. 14 is a flowchart illustrating performing a PTP procedure to which schemes for improving errors are applied according to an embodiment of the disclosure;

FIG. 15 is a flowchart illustrating performing a PTP procedure to which schemes for improving errors are applied according to an embodiment of the disclosure;

FIG. 16 is a flowchart illustrating performing a PTP procedure to which schemes for improving errors are applied according to an embodiment of the disclosure;

FIG. 17 is a flowchart illustrating performing a PTP procedure to which schemes for improving errors are applied according to an embodiment of the disclosure;

FIG. 18 is a diagram illustrating protocol layers within a device in which commands for configurations related to schemes for improving errors in a PTP procedure may be transmitted/received with each other according to an embodiment of the disclosure;

FIG. 19 is a diagram illustrating a command for controlling parameter configurations for PTP traffic according to an embodiment of the disclosure;

FIG. 20 is a diagram illustrating a command for updating AC parameter configurations according to an embodiment of the disclosure;

FIG. 21 is a diagram illustrating a method performed by a first device according to an embodiment of the disclosure;

FIG. 22 is a diagram illustrating a method performed by a second device according to an embodiment of the disclosure; and

FIG. 23 is a block diagram of an external electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the accompanying drawings, some elements may be exaggerated, omitted, or schematically illustrated. In addition, the size of each element does not completely reflect the actual size. In the respective drawings, the same or corresponding elements are assigned the same reference numerals.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

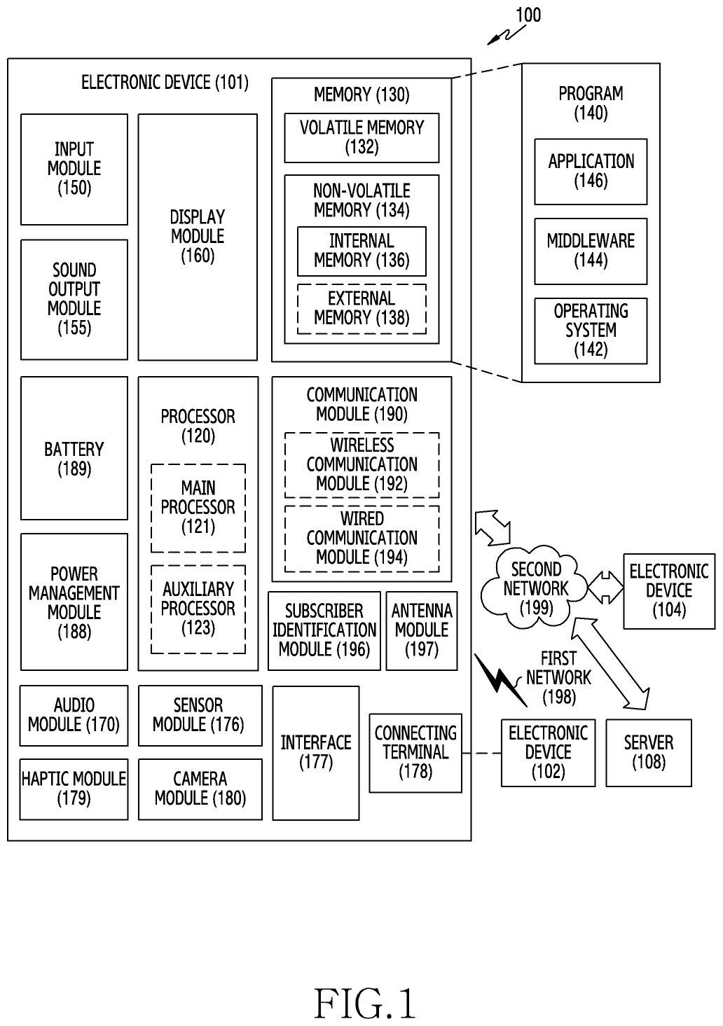

FIG. 1 is a block diagram of an electronic device in a network environment according to an embodiment of the disclosure.

FIG. 1 illustrates an electronic device 101 in a network environment 100 according to various embodiments.

Referring to FIG. 1, the electronic device 101 in the network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit, a neural processing unit (NPU), an image signal processor, a sensor hub processor, or a communication processor) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control, for example, at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active (e.g., executing an application) state. According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for processing of an artificial intelligence model. The artificial model may be generated through machine learning. Such learning may be performed, e.g., by the electronic device 101 where the artificial intelligence model is performed or via a separate server (e.g., the server 108). Learning algorithms may include, but are not limited to, for example, supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof, but is not limited thereto. Additionally or alternatively, the artificial intelligence model may include a software structure, in addition to the hardware structure.

The memory 130 may store various data used by at least one component (e.g., the processor 120 or the sensor module 176) of the electronic device 101. The data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing back multimedia or records. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or an external electronic device (e.g., the external electronic device 102 (e.g., a speaker or a headphone)) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly or wirelessly. According to an embodiment of the disclosure, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the external electronic device 102). According to an embodiment of the disclosure, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be incorporated into a single component (e.g., a single chip), or may be implemented as multi components (e.g., multiple chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support high-speed transmission of high-capacity data (enhanced mobile broadband (eMBB)), terminal power minimization and multi-terminal access (massive machine type communications (mMTC)), or ultra-reliable and low-latency communications (URLLC). The wireless communication module 192 may support a high-frequency band (e.g., the millimeter-wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197. According to an embodiment of the disclosure, the antenna module 197 may form a mmWave antenna module. According to an embodiment of the disclosure, the mmWave antenna module may include a printed circuit board, an RFIC disposed at a first surface (e.g., the lower surface) of the printed circuit board or adjacent thereto and capable of supporting specified high-frequency bands (e.g., mmWave bands), and a plurality of antennas (e.g., an array antenna) disposed at a second surface (e.g., the upper or side surface) of the printed circuit board or adjacent thereto and capable of transmitting or receiving signals in the specified high-frequency bands.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To this end, a cloud computing, distributed computing, mobile edge computing (MEC), or client-server computing technology may be used, for example. The electronic device 101 may provide, for example, an ultra-low-latency service using distributed computing or MEC. In another embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments set forth herein may be one of various types of electronic devices. The electronic device may include, for example, a portable communication device (e.g., a smart phone), a computer device, a portable multimedia device, a portable medical device, a camera, a wearable device, or a home appliance. The electronic device according to embodiments of the disclosure is not limited to those described above.

It should be appreciated that the embodiments and the terms used therein are not intended to limit the technological features set forth herein to particular embodiments and the disclosure includes various changes, equivalents, or alternatives for a corresponding embodiment. With regard to the description of the drawings, similar reference numerals may be used to designate similar or relevant elements. A singular form of a noun corresponding to an item may include one or more of the items, unless the relevant context clearly indicates otherwise. As used herein, each of such phrases as “A or B,” “at least one of A and B,” “at least one of A or B,” “A, B, or C,” at least one of A, B, and C,” and “at least one of A, B, or C,” may include all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order). If an element (e.g., a first element) is referred to, with or without the term “operatively” or “communicatively”, as “coupled with/to” or “connected with/to” another element (e.g., a second element), it means that the element may be coupled/connected with/to the other element directly (e.g., wiredly), wirelessly, or via a third element.

As used in various embodiments of the disclosure, the term “module” may include a unit implemented in hardware, software, or firmware, and may be interchangeably used with other terms, for example, “logic,” “logic block,” “component,” or “circuit”. The “module” may be a single integrated component, or a minimum unit or part thereof, adapted to perform one or more functions. For example, according to an embodiment of the disclosure, the “module” may be implemented in the form of an application-specific integrated circuit (ASIC).

Various embodiments as set forth herein may be implemented as software (e.g., the program 140) including one or more instructions that are stored in a storage medium (e.g., the internal memory 136 or external memory 138) that is readable by a machine (e.g., the electronic device 101). For example, a processor (e.g., the processor 120) of the machine (e.g., the electronic device 101) may invoke at least one of the one or more stored instructions from the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Herein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, methods according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each element (e.g., a module or a program) of the above-described elements may include a single entity or multiple entities, and some of the multiple entities may be separately disposed in another element. According to various embodiments of the disclosure, one or more of the above-described elements or operations may be omitted, or one or more other elements or operations may be added. Alternatively or additionally, a plurality of elements (e.g., modules or programs) may be integrated into a single element. In such a case, according to various embodiments of the disclosure, the integrated element may still perform one or more functions of each of the plurality of elements in the same or similar manner as they are performed by a corresponding one of the plurality of elements before the integration. According to various embodiments of the disclosure, operations performed by the module, the program, or another element may be carried out sequentially, in parallel, repeatedly, or heuristically, or one or more of the operations may be executed in a different order or omitted, or one or more other operations may be added.

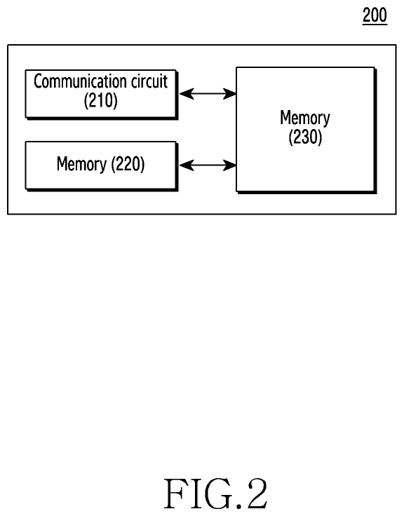

FIG. 2 is a block diagram of an electronic device according to an embodiment of the disclosure.

Referring to FIG. 2, an electronic device 200 (e.g., the electronic device 101 of FIG. 1) may include a communication circuit 210 (e.g., the wireless communication module 192 of FIG. 1) configured to transmit and receive signals using one or more antennas with an external electronic device, memory 220 (e.g., the memory 130 of FIG. 1) configured to store instructions for the operation of the electronic device 200, and a processor 230 (e.g., the processor 120 of FIG. 1) which may be implemented as one or more single-core processors or one or more multi-core processors.

The communication circuit 210 may include various circuit structures used for modulation and/or demodulation of signals within the electronic device 200. For example, the communication circuit 210 may modulate a baseband signal into a radio frequency (RF) signal so as to be output through an antenna (not illustrated), may demodulate an RF signal received through the antenna into a baseband signal, and may transmit the same to the processor 230.

The communication circuit 210 may support at least one of various wired/wireless communication methods. For example, the communication circuit 210 may be in the form of a chipset, or may be a sticker/barcode (e.g., a sticker including an NFC tag) containing information necessary for communication. The communication circuit 210 may support, for example, cellular communication, wireless fidelity (Wi-Fi), Wi-Fi Direct, Bluetooth, ultra-wideband (UWB), or near field communication (NFC).

In one embodiment of the disclosure, the communication circuit 210 may support two frequency bands simultaneously, that is, dual band. For example, the communication circuit 210 may support real simultaneous dual band (RSDB) and/or dual band dual concurrent (DBDC) functions. Accordingly, the electronic device 200 may be simultaneously connected to two frequency bands. For example, the electronic device 200 may be simultaneously connected to the 2.4 gigahertz (GHz) band and the 5 GHz or 6 GHz band.

Various types of data, such as applications, instructions, programs, and files, may be installed and stored in the memory 220. The processor 230 may access data stored in the memory 220 to utilize the same or may store new data in the memory 220. In one embodiment of the disclosure, programs and data for transmitting/receiving audio data may be installed and stored in the memory 220.

The processor 230 may control the overall operation of the electronic device 200. In one embodiment of the disclosure, the processor 230 may control other components included in the electronic device 200 to enable the electronic device 200 to transmit/receive audio data. For example, the processor 230 may execute programs or instructions stored in the memory 220, may read files stored in the memory 220, or may store new files in the memory 220.

In one embodiment of the disclosure, the description that the processor 230 performs an operation may mean that the processor 230 directly performs the operation or that the processor 230 controls another component, for example, the communication circuit 210, to perform the operation.

In one embodiment of the disclosure, the processor 230 may transmit/receive audio data by executing a program stored in the memory 220.

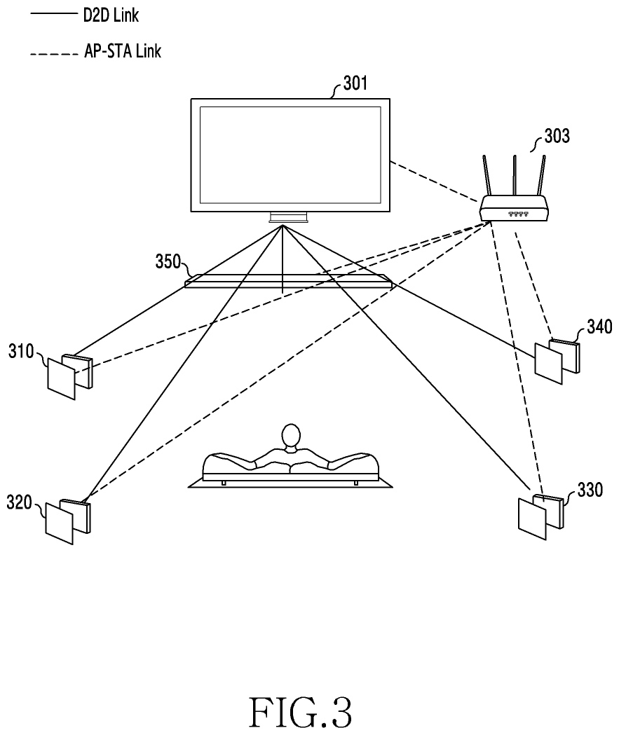

FIG. 3 is a diagram illustrating a system to which a synchronization method may be applied according to an embodiment of the disclosure.

Referring to FIG. 3, the first device 301 may be connected to the second device 310, the third device 320, the fourth device 330, the fifth device 340, and the sixth device 350, respectively. The connection between the first device 301 and each of the second device 310, the third device 320, the fourth device 330, the fifth device 340, and the sixth device 350 may be formed through device-to-device (D2D) connection or through an indirect connection via an access point (AP) 303. Synchronization according to an embodiment of the disclosure may refer to an operation of aligning the reference timepoint for data transmission from the first device 301 and the reference timepoint for data transmission from each of the second device 310, the third device 320, the fourth device 330, the fifth device 340, and the sixth device 350 to the same timepoint. After synchronization according to an embodiment of the disclosure is performed, the reference timepoint for data transmission from the first device 301 and the reference timepoint for data transmission from each of the second device 310, the third device 320, the fourth device 330, the fifth device 340, and the sixth device 350 are aligned to the same timepoint. As a result, data transmission from the first device 301 and data transmission from each of the second device 310, the third device 320, the fourth device 330, the fifth device 340, and the sixth device 350 may occur at the same timepoint, thereby providing the user with a high-quality multimedia experience. For example, the data transmitted by the first device 301 may be video data, and the first device 301 may be a device, such as a TV. In addition, the data transmitted by each of the second device 310, the third device 320, the fourth device 330, the fifth device 340, and the sixth device 350 may be audio data, and the second device 310, the third device 320, the fourth device 330, the fifth device 340, and the sixth device 350 may be devices such as speakers.

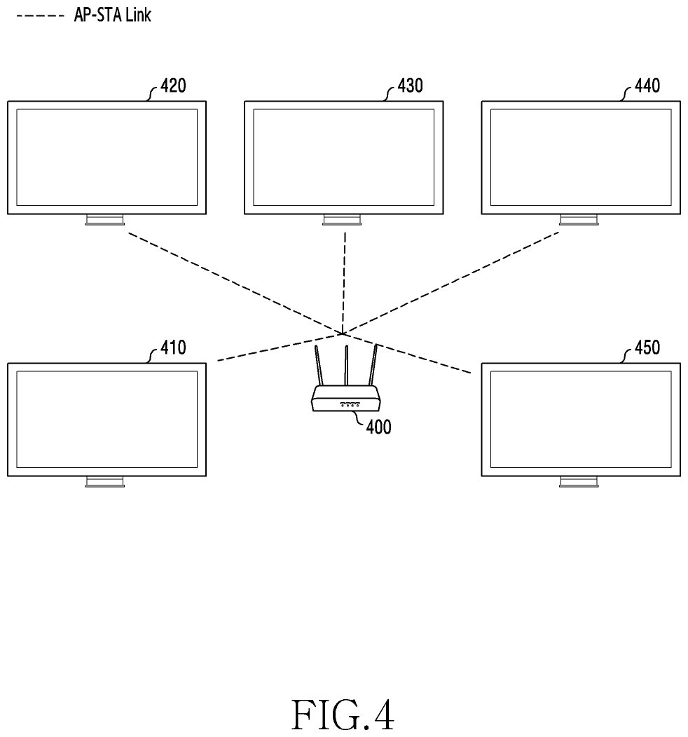

FIG. 4 is a diagram illustrating a system to which a synchronization method may be applied according to an embodiment of the disclosure.

Referring to FIG. 4, the first device 410, the second device 420, the third device 430, the fourth device 440, and the fifth device 450 may each establish a connection with the access point (AP) 400. In the example of FIG. 4, synchronization according to an embodiment of the disclosure may refer to an operation of aligning the reference timepoint for data transmission from each of the first device 410, the second device 420, the third device 430, the fourth device 440, and the fifth device 450 to the same timepoint. After synchronization according to an embodiment of the disclosure is performed, the reference timepoint for data transmission from each of the first device 410, the second device 420, the third device 430, the fourth device 440, and the fifth device 450 is aligned to the same timepoint, and data transmission from each of the first device 410, the second device 420, the third device 430, the fourth device 440, and the fifth device 450 may thus occur at the same timepoint, thereby providing the user with a high-quality multimedia experience. For example, the data transmitted by the first device 410, the second device 420, the third device 430, the fourth device 440, and the fifth device 450 may be video data, and the first device 410, the second device 420, the third device 430, the fourth device 440, and the fifth device 450 may be devices, such as TVs.

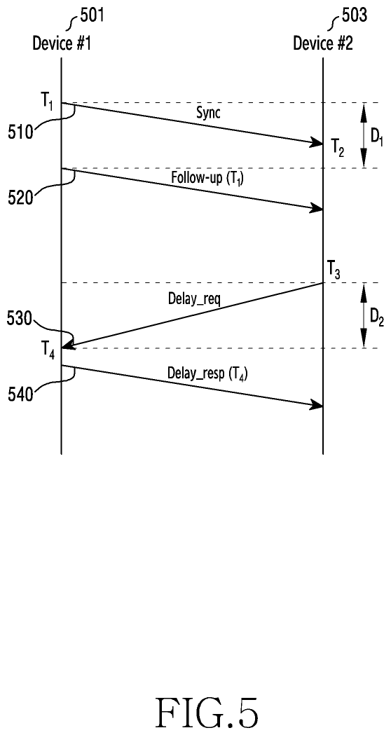

FIG. 5 is a flowchart illustrating a procedure in which a synchronization method is performed according to an embodiment of the disclosure.

Referring to FIG. 5, device #1 501 may transmit a first message for synchronization to device #2 503 at timepoint T₁ at operation 510. Device #2 503 may then receive the first message transmitted by device #1 501 at timepoint T₂, and device #2 503 may acquire and store the timepoint T₂ at which the first message was received.

Next, device #1 501 may transmit a second message including information regarding timepoint T₁ at which device #1 501 transmitted the first message, to device #2 503 at operation 520. The second message may be referred to as a “follow-up message.” Device #2 503 may then acquire information regarding timepoint T₁ at which device #1 501 transmitted the first message, through the second message. Based on the previously stored information regarding T₂ and the information regarding T₁ acquired through the second message, device #2 503 may acquire the offset (D1 value) between the timepoint T₁ at which device #1 501 transmitted the first message and timepoint T₂ at which device #2 503 received the first message, by subtracting the T₁ value from the T₂ value.

Subsequently, device #1 501 may receive a third message from device #2 503 at timepoint T₄ at operation 530. Device #2 503 may acquire and store the timepoint T₃ at which device #2 503 transmitted the third message. In addition, device #1 501 may acquire and store the timepoint T₄ at which the third message was received.

Next, device #1 501 may transmit a fourth message including information regarding the timepoint T₄ at which the third message was received, to device #2 503 at operation 540. Device #2 503 may then acquire information regarding the timepoint T₄ at which device #1 501 received the third message, through the fourth message. Based on the previously stored information regarding T₃ and the information regarding T₄ acquired through the fourth message, device #2 503 may acquire the offset (D2 value) between the timepoint T₄ at which device #1 501 received the third message and timepoint T₃ at which device #2 503 transmitted the third message, by subtracting the T₃ value from the T₄ value.

Through the D1 value and D2 value acquired through the above operations, the symmetric delay value and offset value may be acquired according to Equation 1 below:

$$Symmetric delay : δ = \frac{{D}_{1} + {D}_{2}}{2} = \frac{( {T}_{2} - {T}_{1} ) + ( {T}_{4} - {T}_{3} )}{2} \qquad Equation 1$$

$$Offset : o = \frac{{D}_{1} - D 2}{2} = \frac{( {T}_{2} - {T}_{1} ) - ( {T}_{4} - {T}_{3} )}{2}$$

Based on the acquired symmetric delay value and offset value, synchronization between device #1 501 and device #2 503 may be accomplished. For example, the reference timepoint for data transmission from device #1 501 and the reference timepoint for data transmission from device #2 503 may be assigned to the same timepoint. The synchronization procedure described with reference to FIG. 5 may be referred to as a software (SW)-based precision timing protocol (PTP).

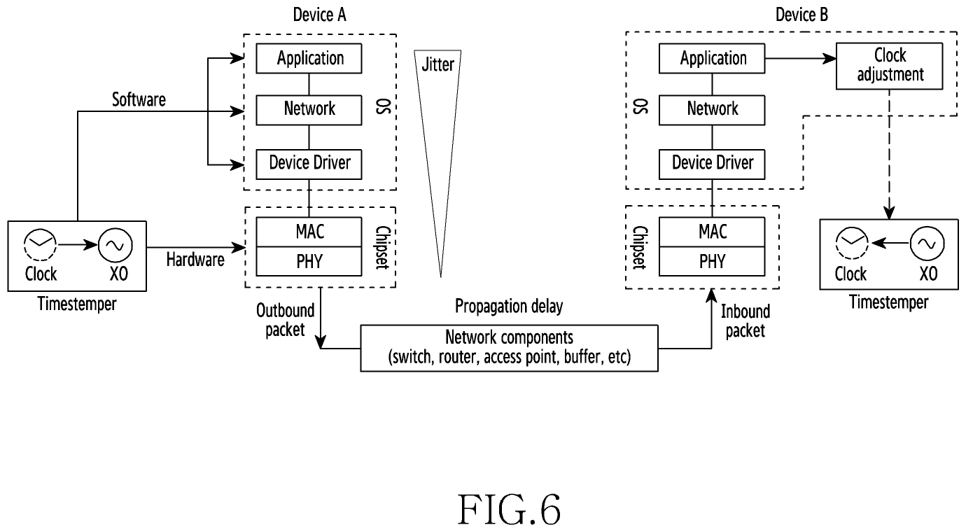

FIG. 6 is a diagram illustrating problems of an SW-based PTP procedure according to an embodiment of the disclosure.

More specifically, FIG. 6 is a diagram for describing the frame delay change (jitter), which is one of various problems in the SW-based PTP procedure, occurring as PTP synchronization packets are transferred through a network. Jitter refers to temporal variation or instability occurring in digital signals or data transmission. In the case of data communication, jitter may refer to a phenomenon where packet delay is not constant, varies frequently, and the interval between packets is not uniform. Jitter may be used as a measure of variability in delay time in a network.

Referring to FIG. 6, in the case of timestamping in the SW-based PTP procedure, delays and variations may occur as the timestamp passes through the software stack, which generates jitter. In addition, referring to FIG. 6, toward the upper layer of the protocol, the jitter generated in each layer may accumulate, thereby increasing the magnitude of jitter toward the upper layer.

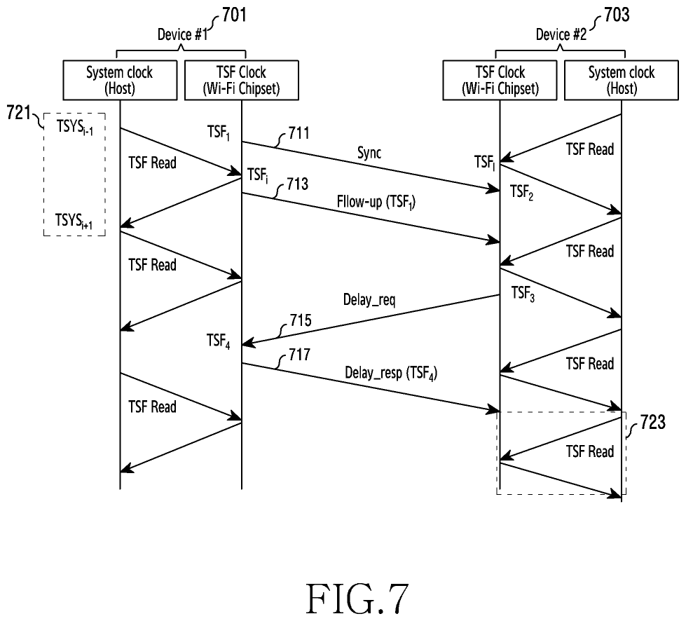

In order to address such problems in the SW-based PTP procedure, a hardware (HW)-based PTP procedure may be used. In the case of the HW-based PTP procedure, the system clock and the timing synchronization function (TSF) clock of each of the two devices participating in the PTP procedure may be used together. As a result of performing the HW-based PTP procedure, the system clock of one of the two devices participating in the PTP procedure may be synchronized with the system clock of the other device. Hereinafter, the HW-based PTP procedure will be described in more detail with reference to FIG. 7.

FIG. 7 is a flowchart illustrating an HW-based PTP procedure according to an embodiment of the disclosure.

Referring to FIG. 7, the overall sequence of the HW-based PTP procedure will be described as follows:
(1) The TSF clock of device #1 701 is synchronized with the system clock of Device #1 701.
(2) The TSF clock of device #2 703 is synchronized with the TSF clock of device #1 701, which is synchronized with the system clock of device #1 701. In this regard, the SW-based PTP procedure described with reference to FIG. 5 may be applied to synchronize the TSF clock of device #2 703 with the TSF clock of device #1 701.
(3) The system clock of device #2703 is synchronized with the TSF clock of device #2 703, which is synchronized with the TSF clock of device #1 701.

Through the above procedures (1) to (3), the system clock of device #1 701 and the system clock of device #2 703 may be synchronized.

Referring to FIG. 7, the HW-based PTP procedure will be described in more detail. First, device #1 701 may perform a TSF clock read operation 721 to synchronize the TSF clock of device #1 701 with the system clock of device #1 701. As a result of performing the TSF clock read operation 721, a TSF clock value corresponding to the timepoint at which the TSF clock read operation 721 was performed may be acquired. In the case of FIG. 7, TSF clock value TSFᵢ may be acquired through the TSF clock read operation 721 performed between timepoint TSYSᵢ₋₁ and timepoint TSYSᵢ₊₁. Device #1 701 may repeatedly perform the TSF clock read operation 721, and among the acquired TSF clock values corresponding to the repeatedly performed TSF clock read operations 721, the TSF clock value acquired through the TSF clock reading that has the smallest interval between the timepoint TSYSᵢ₋₁ at which the TSF clock read operation 721 of the system clock of device #1 701 was initiated and the timepoint TSYSᵢ₊₁ at which the TSF clock read operation 721 of the system clock was completed may be determined as the TSF clock value (TSF₁ in the case of FIG. 7) used in the synchronization procedure. The TSF clock value TSF₁ used in the synchronization procedure of FIG. 7 may be a value acquired according to the TSF clock read operation performed prior to the timepoint illustrated in FIG. 7.

Device #1 701 may transmit a first message for synchronization to device #2 703 at timepoint TSF₁, based on the TSF clock value synchronized with the system clock of device #1 701 at operation 711. Device #2 703 may receive the first message transmitted by device #1 701 at timepoint TSF₂, and device #2 703 may acquire and store the timepoint TSF₂ at which the first message was received.

Next, device #1 701 may transmit a second message including information regarding the timepoint TSF₁ at which device #1 701 transmitted the first message, to device #2 703 at operation 713. The second message may be referred to as “follow-up message.” Device #2 703 may acquire information regarding the timepoint TSF₁ at which device #1 701 transmitted the first message, through the second message. Based on the previously stored information regarding TSF₂ and the information regarding TSF₁ acquired through the second message, device #2 703 may acquire the offset value between the timepoint TSF₁ at which device #1 701 transmitted the first message and the timepoint TSF₂ at which device #2 703 received the first message, by subtracting the TSF₁ value from the TSF₂ value.

Thereafter, device #1 701 may receive a third message from device #2 703 at timepoint TSF₄ at operation 715. Device #2 703 may acquire and store the timepoint TSF₃ at which device #2 703 transmitted the third message. In addition, device #1 701 may acquire and store timepoint TSF₄ at which the third message was received.

Next, device #1 701 may transmit a fourth message including information regarding the timepoint TSF₄ at which the third message was received, to device #2 703 at operation 717. Device #2 703 may acquire information regarding the timepoint TSF₄ at which device #1 701 received the third message, through the fourth message. Based on the previously stored information regarding TSF₃ and the information regarding TSF₄ acquired through the fourth message, device #2 703 may acquire the offset value between the timepoint TSF₄ at which device #1 701 received the third message and the timepoint TSF₃ at which device #2 703 transmitted the third message, by subtracting the TSF₃ value from the TSF₄ value.

Through the TSF₁ to TSF₄ values acquired through the above operations, the symmetric delay value and TSF offset value may be acquired according to Equation 2 below:

$$Symmetric delay : δ = \frac{( {TSF}_{2} - {TSF}_{1} ) + ( {TSF}_{4} - {TSF}_{3} )}{2} \qquad Equation 2$$

$$TSF Offset : o = \frac{( {TSF}_{2} - {TSF}_{1} ) - ( {TSF}_{4} - {TSF}_{3} )}{2}$$

Based on the acquired symmetric delay value and offset value, synchronization between device #1 701 and device #2 703 may be accomplished. For example, the system clock of device #1 701 and the system clock of device #2 703 may be aligned.

In addition, assuming that the TSF clock value acquired through the TSF clock reading that has the smallest interval between the timepoint TSYSᵢ₋₁ at which the TSF clock read operation 721 of the system clock of device #1 701 is initiated and the timepoint TSYSᵢ₊₁ at which the TSF clock read operation 721 of the system clock is completed is referred to as TSFₖ, the system clock offset delay of device #1 701 after synchronization may be defined as in Equation 3 below:

$${Δ}_{1} = {TSF}_{k} - \frac{( {TSYS}_{k - 1} - {TSYS}_{k + 1} )}{2} \qquad Equation 3$$

In addition, assuming that the interval between the timepoint TSYSⱼ₋₁ at which the TSF clock read operation of the system clock of device #2 703 is initiated and the timepoint TSYSⱼ₊₁ at which the TSF clock read operation of the system clock is completed is the smallest among the intervals between the initiation/completion timepoints of the repeatedly performed TSF clock read operations, and that the TSF clock value acquired in this regard is referred to as TSFᵢ, the system clock offset delay of device #2 703 after synchronization may be defined as in Equation 4 below:

$${Δ}_{2} = {TSF}_{l} - \frac{( {TSYS}_{j - 1} - {TSYS}_{j + 1} )}{2} \qquad Equation 4$$

As described above, a HW-based PTP procedure may be used to compensate for the disadvantages of a SW-based PTP procedure. However, since the first message to the fourth message used in the PTP procedure are transmitted based on a contention-based transmission scheme, the transmitting device may be given no transmission opportunity to transmit the first to fourth messages. In addition, retransmission may be performed because, although the first message to the fourth message have been transmitted, the messages fail to be normally transmitted to the receiving device. In case that the transmitting device is given no transmission opportunity to transmit the first to fourth messages as described above, or multiple retransmissions are performed, the corresponding messages will be transmitted at a timepoint delayed from the time at which the corresponding messages should have been transmitted. Accordingly, even if the synchronization procedure is completed, synchronization between devices may not be performed normally.

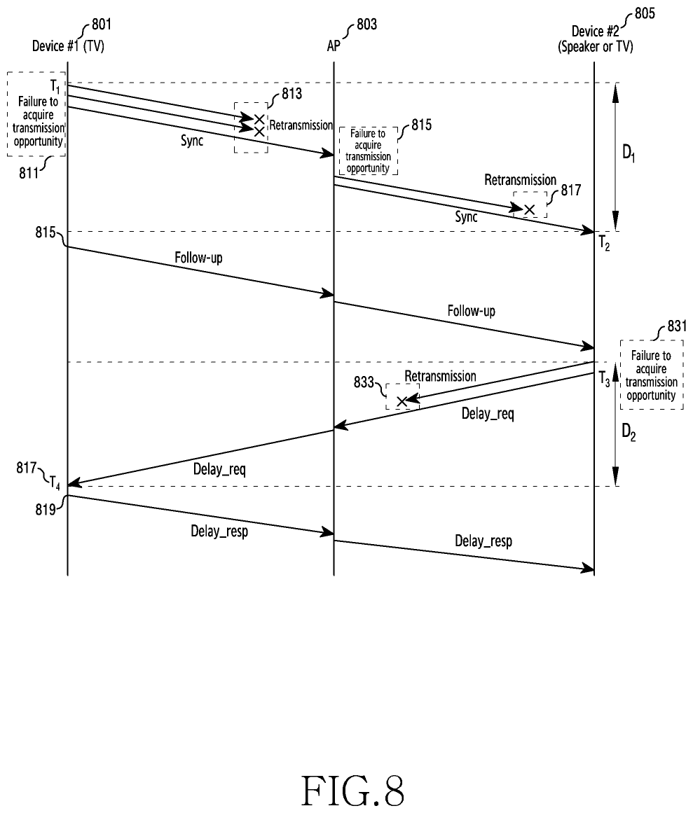

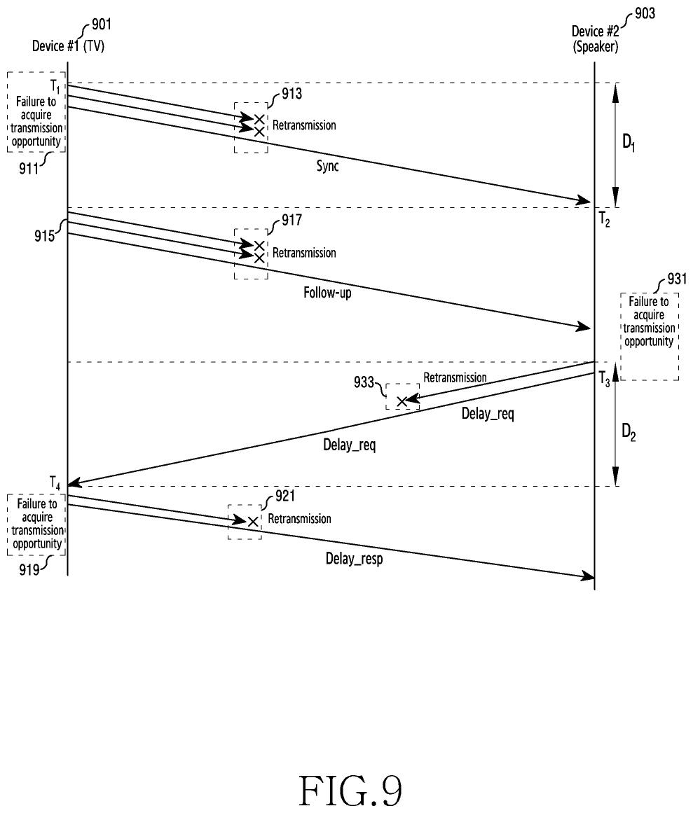

Hereinafter, with reference to FIGS. 8 and 9, a case where a synchronization error occurs due to delay caused by failed transmission opportunity acquisition and retransmission will be described in more detail.

FIG. 8 is a diagram illustrating a case where an error occurs while performing a PTP procedure due to delay caused by failed transmission opportunity acquisition and retransmission according to an embodiment of the disclosure.

Referring to FIG. 8, device #1 801 may transmit a first message for synchronization to the AP 803 at timepoint T₁ at operation 811. However, since the transmission of the first message at the corresponding timepoint T₁ is based on contention with other devices, device #1 801 may fail to acquire a transmission opportunity to transmit the first message at timepoint T₁ due to transmissions from other devices. As device #1 801 fails to acquire the transmission opportunity to transmit the first message at timepoint T₁, the first message fails to be transmitted at timepoint T₁ at which the first message should have been transmitted, and a delay may occur until the timepoint at which device #1 801 acquires the next transmission opportunity. Thereafter, device #1 801 acquires the transmission opportunity and transmits the first message, but for a predetermined reason, the first message may fail to be transmitted to the AP 803 at once, and retransmission may be performed one or more times at operation 813. As the retransmission is performed, additional delay occurs.

Next, the AP 803 that received the first message from device #1 801 transmits the first message to device #2 805. For the same/similar reasons as described above, the AP 803 may also fail to acquire a transmission opportunity at operation 821 and thus perform retransmission at operation 823, thereby incurring additional delay. The timepoint T₂ at which device #2 805 finally receives the first message may be a timepoint reflecting the delay due to the failed transmission opportunity acquisition and retransmission at each of device #1 801 and AP 803. Device #2 805 may acquire and store timepoint T₂ at which the first message is received after a delay corresponding to the delay time due to the failed transmission opportunity acquisition and retransmission.

Next, device #1 801 may transmit a second message including information regarding the timepoint T₁ at which device #1 801 should have transmitted the first message without delay, to the AP 803 at operation 815. The AP 803 may transmit the second message including information regarding the timepoint T₁ at which device #1 801 should have transmitted the first message without delay, to device #2 805.

Device #2 805 may then acquire information regarding the timepoint T₁ at which device #1 801 should have transmitted the first message without delay, through the second message. Based on the previously stored information regarding T₂ and the information regarding T₁ acquired through the second message, device #2 805 may acquire the offset (D1 value) between the timepoint T₁ at which device #1 801 should have transmitted the first message without delay and the timepoint T₂ at which device #2 805 received the second message, by subtracting the T₁ value from the T₂ value. Since the timepoint T₂ is determined based on the first message transmitted at a timepoint delayed from the timepoint T₁, the D1 value calculated by device #2 805 is calculated to be a larger value than the value expected in the case where the first message is transmitted without delay (that is, the T₂ value is determined/measured/acquired as a larger value than when no delay occurs), and an error may thus occur.

Thereafter, device #1 801 may receive the third message from the AP 803 at timepoint T₄, and may acquire and store the timepoint T₄ at which the third message was received at operation 817. However, for the same/similar reasons as described above, device #2 803 may also fail to acquire a transmission opportunity at operation 831 and thus perform retransmission at operation 833. Accordingly, additional delay may occur when device #2 805 transmits the third message. Therefore, the timepoint T₄ at which device #1 801 received the third message is determined to be a timepoint delayed from the timepoint expected in the case where the third message is transmitted without delay, and the T₄ value stored by device #1 801 is determined to be a value larger than the value expected in the case where the third message is transmitted without delay. Device #2 805 may store information regarding the timepoint T₃ at which the third message should have been transmitted without delay.

Next, device #1 801 may transmit a fourth message including information regarding the timepoint T₄ at which the third message was received, to the AP 803 at operation 819. The AP 803 may transmit the received third message to device #2 805. Device #2 805 may then acquire information regarding the timepoint T₄ at which device #1 801 received the third message, through the fourth message. Based on the previously stored information regarding T₃ and the information regarding T₄ acquired through the fourth message, device #2 805 may acquire the offset (D2 value) between the timepoint T₄ at which device #1 801 received the third message and the timepoint T₃ at which device #2 805 transmitted the third message, by subtracting the T₃ value from the T₄ value. Since the timepoint T₄ is determined based on the third message transmitted at a timepoint delayed from the timepoint T₃, the D2 value calculated by device #2 805 is calculated to be a larger value than the value expected in the case where the third message is transmitted without delay (that is, the T₄ value is determined/measured/acquired as a larger value than when no delay occurs), and an error may thus occur. The value of the error occurring when calculating the D1/D2 value described above may increase in proportion to the number of times failed transmission opportunity acquisition and retransmission occur.

FIG. 9 is a diagram illustrating a case where an error occurs while performing a PTP procedure due to delay caused by failed transmission opportunity acquisition and retransmission according to an embodiment of the disclosure.

Referring to FIG. 9, device #1 901 may transmit a first message for synchronization to device #2 903 at timepoint T₁ at operation 911. However, since the transmission of the first message at the corresponding timepoint T₁ is based on contention with other devices, device #1 901 may fail to acquire a transmission opportunity to transmit the first message at timepoint T₁ due to transmissions from other devices. As device #1 901 fails to acquire the transmission opportunity to transmit the first message at timepoint T₁, the first message fails to be transmitted at timepoint T₁ at which the first message should have been transmitted, and a delay may occur until the timepoint at which device #1 901 acquires the next transmission opportunity. Thereafter, device #1 901 acquires the transmission opportunity and transmits the first message, but for a predetermined reason, the first message may fail to be transmitted to device #2 903 at once, and retransmission may be performed one or more times at operation 913. As the retransmission is performed, additional delay occurs. Accordingly, the timepoint T₂ at which device #2 receives the first message may be a timepoint reflecting the delay due to the failed transmission opportunity acquisition and retransmission at device #1 901. Device #2 903 may acquire and store timepoint T₂ at which the first message is received after a delay corresponding to the delay time due to the failed transmission opportunity acquisition and retransmission.

Next, device #1 901 may transmit a second message including information regarding the timepoint T₁ at which device #1 901 should have transmitted the first message without delay, to device #2 903 at operation 915. Device #2 903 may then acquire information regarding the timepoint T₁ at which device #1 901 should have transmitted the first message without delay, through the second message. During the second message transmission, (although not illustrated) failed transmission opportunity acquisition and retransmission 917 may be performed, and the second message may accordingly be transmitted with delay. However, the second message is used to provide device #2 903 with information regarding the timepoint T₁ of transmission of the first message, and the second message's transmission/reception timepoint is not used to calculate the offset D1. Therefore, a failure to acquire a transmission opportunity regarding the second message and a retransmission may not be a factor affecting the occurrence of errors. Based on the previously stored information regarding timepoint T₂ at which the first message was received with delay and the information regarding T₁ acquired through the second message, device #2 903 may acquire the offset (D1 value) between the timepoint T₁ at which device #1 901 should have transmitted the first message without delay and the timepoint T₂ at which device #2 903 received the second message, by subtracting the T₁ value from the T₂ value. Since the timepoint T₂ is determined based on the first message transmitted at a timepoint delayed from the timepoint T₁, the D1 value calculated by device #2 903 is calculated to be a larger value than the value expected in the case where the first message is transmitted without delay (that is, the T₂ value is determined as a larger value than when no delay occurs), and an error may thus occur.

Thereafter, device #1 901 may receive the third message from device #2 903 at timepoint T₄, and may acquire and store the timepoint T₄ at which the third message was received. However, for the same/similar reasons as described above, device #2 903 may also fail to acquire a transmission opportunity at operation 931 and thus perform retransmission at operation 933. Accordingly, additional delay may occur when device #2 903 transmits the third message. Therefore, the timepoint T₄ at which device #1 901 received the third message is determined to be a timepoint delayed from the timepoint expected in the case where the third message is transmitted without delay, and the T₄ value stored by device #1 901 is determined to be a value larger than the value expected in the case where the third message is transmitted without delay. Device #2 903 may store information regarding the timepoint T₃ at which the third message should have been transmitted without delay.

Next, device #1 901 may transmit a fourth message including information regarding the timepoint T₄ at which the third message was received, to device #2 903 at operation 919. Device #2 903 may then acquire information regarding the timepoint T₄ at which device #1 901 received the third message, through the fourth message. During the fourth message transmission, failed transmission opportunity acquisition and retransmission 921 may be performed, and the fourth message may accordingly be transmitted with delay. However, the fourth message is used to provide device #2 903 with information regarding the timepoint T₄ of reception of the third message, and the fourth message's transmission/reception timepoint is not used to calculate the offset D2. Therefore, a failure to acquire a transmission opportunity regarding the fourth message and a retransmission may not be a factor affecting the occurrence of errors. Based on the previously stored information regarding timepoint T₃ and the information regarding T₄ acquired through the fourth message, device #2 903 may acquire the offset (D2 value) between the timepoint T₄ at which device #1 901 received the third message and the timepoint T₃ at which device #2 903 received the third message, by subtracting the T₃ value from the T₄ value. Since the timepoint T₄ is determined based on the third message transmitted at a timepoint delayed from the timepoint T₃, the D2 value calculated by device #2 is calculated to be a larger value than the value expected in the case where the third message is transmitted without delay (that is, the T₄ value is determined/measured/acquired as a larger value than when no delay occurs), and an error may thus occur. The value of the error occurring when calculating the D1/D2 value described above may increase in proportion to the number of times failed transmission opportunity acquisition and retransmission occur.

In order to improve the occurrence of errors due to message transmission delays in the aforementioned PTP procedure, it is necessary to ensure that, when a transmission opportunity is not acquired during the transmission of a PTP procedure-related message, the transmitting device can acquire the next transmission opportunity as quickly as possible, or that the PTP procedure-related message can be delivered to the receiving device in a single transmission without retransmission. Hereinafter, schemes for improving the occurrence of errors due to message transmission delays in the aforementioned PTP procedure will be described.

First, a scheme for improving the occurrence of errors due to delays caused by retransmission of PTP procedure-related messages will be described.

In order to improve the occurrence of errors due to delays caused by retransmission of PTP procedure-related messages, it is possible to configure the use of a robust modulation and coding scheme (MCS) limited to PTP messages/packets. According to this scheme, among all MCS candidate values applicable to message/packet transmission, an MCS value with high transmission reliability may be fixed with regard to PTP messages/packets. Alternatively, even if rate adaptation is applied, reliable MCS values may be selected to form a subset, and rate adaptation may be operated within the selected MCS subset. For example, in the basic rate adaption operation, the elements of the full MCS set may correspond to MCS index 8 to MCS index 15, but if the maximum MCS value is limited to MCS index 11, the modified rate adaptation may apply an MCS such that the elements of the MCS set have values in the range of MCS index 8 to MCS index 11. For example, among all MCS index values, usable candidate MCS index values that can guarantee high transmission reliability are selected, and an MCS configuration corresponding to one fixed MCS index among the usable candidate MCS index values may be applied. Alternatively, any one MCS configuration within an MCS subset configured by MCS configurations corresponding to at least one MCS index below or equal to a specific MCS index among the usable candidate modulation and coding scheme (MCS) index values may be applied.

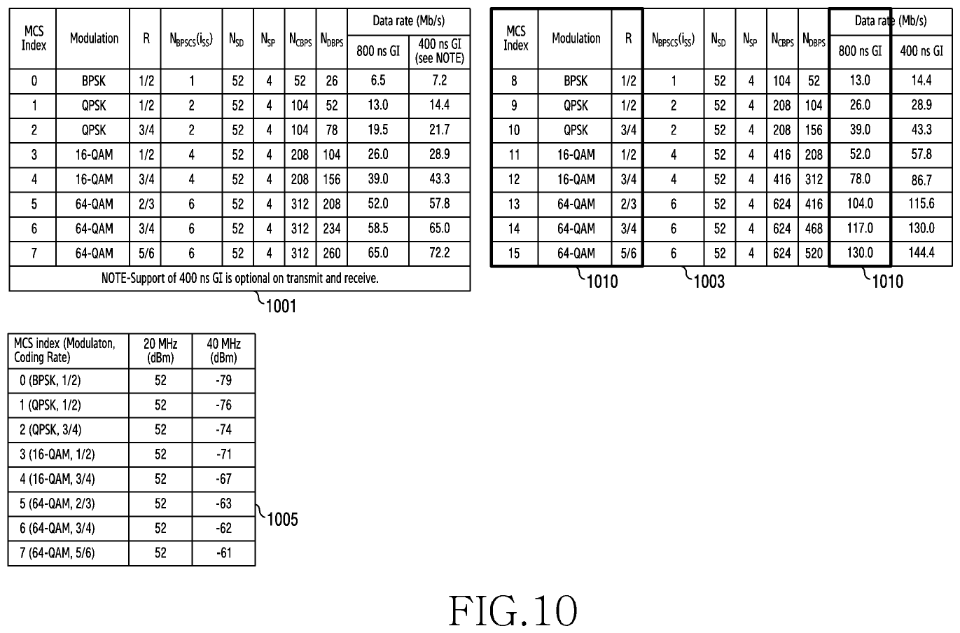

FIG. 10 is a diagram illustrating a scheme for improving an occurrence of errors due to delays caused by retransmission of PTP procedure-related messages according to an embodiment of the disclosure.

Referring to FIG. 10, from the entire MCS tables indicated by 1001 and 1003, only MCSs corresponding to MCS indices 8 to 15 (indicated by 1010) may be applied to PTP message/packet transmission. In case of following a scheme of applying a fixed MCS to PTP messages/packets, only one MCS among the MCSs corresponding to MCS indices 8 to 15 may be fixedly applied to PTP messages/packets. In addition, in case of following a scheme of applying an MCS having a value within a limited rate Adaptation MCS maximum value, any MCS among the MCSs corresponding to MCS indices 8 to 15 may be applied to PTP messages/packets. It is also possible to use a scheme in which an MCS candidate value subset configured by at least one specific MCSs among the MCSs corresponding to MCS indices 8 to 15 is first configured, and any one of the MCS values included in the corresponding subset is applied to PTP messages/packets.

Additionally, in this scheme, the transmission delay of the second message and the fourth message in the PTP procedure may not be factors affecting the occurrence of errors as described above, and the aforementioned MCS application scheme may be applied only to the first message and the third message in the PTP procedure.

It can be understood, referring to FIG. 10, that as the MCS index increases, as the number of spatial streams increases (Nss=2), and when frame aggregation is applied, a higher level of received power is required.

In order to improve the occurrence of errors due to delays caused by retransmission of PTP procedure-related messages, a request to send/clear to send (RTS/CTS) procedure may be applied to PTP messages/packets. The RTS/CTS procedure may be configured to always be applied to PTP messages/packets.

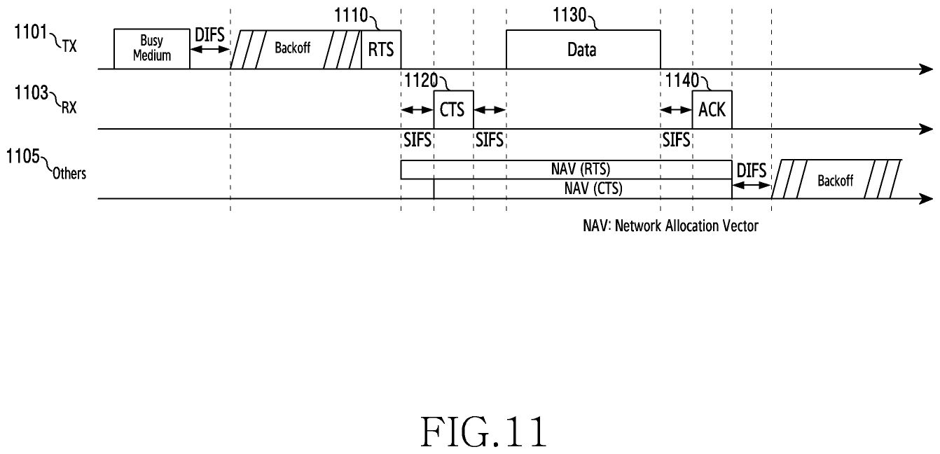

FIG. 11 is a diagram illustrating an RTS/CTS procedure is performed according to an embodiment of the disclosure.

Referring to FIG. 11, the transmitting device 1101 may transmit an RTS (indicated by 1110) to the receiving device 1103 (e.g., an AP), and in response thereto, the receiving device 1103 may transmit a CTS (indicated by 1120) to the transmitting device 1101. During the period after CTS transmission, transmissions from other devices 1105 may not be performed, and during the time when transmissions from other devices 1105 are not performed, the transmitting device 1101 may transmit data (indicated by 1130) without collision with transmissions from other devices 1105 with an acknowledgement (ACK) (indicated by 1140). For example, transmissions from other devices are not performed during the resources secured through the RTS/CTS procedure such that, if the RTS/CTS procedure is performed prior to the transmission of a PTP message/packet, retransmission of the PTP message/packet can be prevented. Additionally, in this scheme, the transmission delays of the second message and the fourth message in the PTP procedure may not be factors affecting the occurrence of errors as described above, and the RTS/CTS procedure may thus be applied only to the first message and the third message in the PTP procedure.

Next, in order to improve the occurrence of errors due to delays caused by a failure to acquire transmission opportunities for transmitting PTP procedure-related messages, the highest priority may be assigned to PTP messages/packets. More specifically, according to the Wi-Fi standard, the following priorities may be defined, and additional priorities applicable to PTP messages/packets may also be defined.
1) Voice (AC_VO): highest priority
2) Video (AC_VI): second priority
3) Best Effort (AC_BE): third priority
4) Background (AC_BK): lowest priority

The priority additionally defined to be applied to PTP messages/packets may be, for example, AC_TS (time sensitive). In case that the transmitting device fails to acquire a transmission opportunity in contention-based transmission, the delay from the timepoint at which the transmission opportunity was not acquired to the timepoint at which an operation to secure the next transmission opportunity is performed may be shorter as the priority is higher. For example, in case that a transmission opportunity regarding a PTP message/packet having the highest priority assigned thereto is not secured, an operation to secure the transmission opportunity regarding the corresponding message/packet may be performed after the smallest delay.

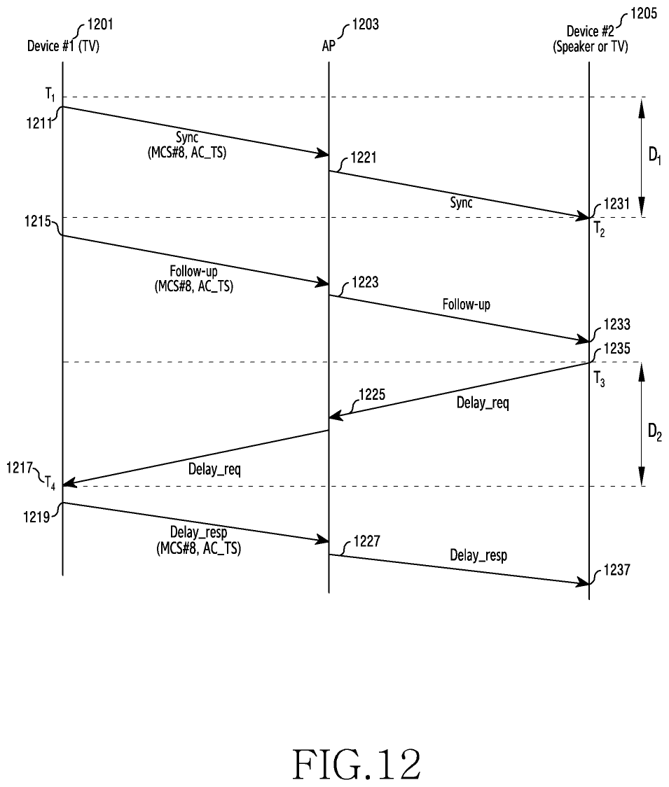

Hereinafter, examples of performing PTP procedures to which schemes for improving errors according to an embodiment of the disclosure are applied will be described with reference to FIGS. 12 to 16.

FIG. 12 is a flowchart illustrating performing a PTP procedure to which schemes for improving errors are applied according to an embodiment of the disclosure. More specifically, the example of FIG. 12 may relate to a case where schemes for improving errors according to an embodiment of the disclosure are applied to an SW-based PTP procedure.

Referring to FIG. 12, device #1 1201 may transmit a first message for synchronization to the AP 1203 at timepoint T₁ at operation 1211. An MCS corresponding to a fixed MCS index for preventing retransmission is applied to the first message, and the highest priority (AC_TS) for securing a transmission opportunity may be configured therefor. Accordingly, additional delays due to performing retransmissions and failed transmission opportunity acquisition are prevented.

Next, upon receiving the first message from device #1 1201, the AP 1203 may transmit the first message to device #2 1205 at operation 1221, and device #2 1205 may acquire and store the timepoint T₂ at which the first message is received at operation 1231.

Next, device #1 1201 may transmit, to the AP 1203, a second message including information regarding timepoint T₁ at which device #1 1201 transmitted the first message at operation 1215. The AP 1203 may transmit, to device #2 1205, a second message including information regarding timepoint T₁ at which device #1 1201 transmitted the first message at operation 1223. Although it is assumed in the illustration in FIG. 12 that an MCS corresponding to a fixed MCS index for preventing retransmission is also applied to the second message, and the highest priority (AC_TS) for securing transmission opportunities is configured therefor, the transmission delay of the second message in the PTP procedure may not be a factor affecting the occurrence of errors, and it is thus unnecessary to apply the fixed MCS index and the highest priority to the second message. Device #2 1205 may acquire, through the second message, information regarding the timepoint T₁ at which device #1 1201 transmitted the first message 1233. Based on the previously stored information regarding T₂ and the information regarding T₁ acquired through the second message, device #2 1205 may acquire the offset (D1 value) between the timepoint T₁ at which device #1 1201 transmitted the first message and the timepoint T₂ at which device #2 1205 received the first message, by subtracting the T₁ value from the T₂ value.

Subsequently, device #1 1201 may receive a third message from the AP 1203 at timepoint T₄, and may acquire and store the timepoint T₄ at which the third message is received at operation 1217. When transmitting the third message, device #2 1205 may apply an MCS corresponding to a fixed MCS index for preventing retransmission to the third message, and may configure the highest priority (AC_TS) for securing transmission opportunities at operation 1235. Accordingly, additional delays due to retransmission of the third message and a failure to secure transmission opportunities are prevented. Device #2 1205 may store information regarding the timepoint T₃ at which the third message was transmitted.

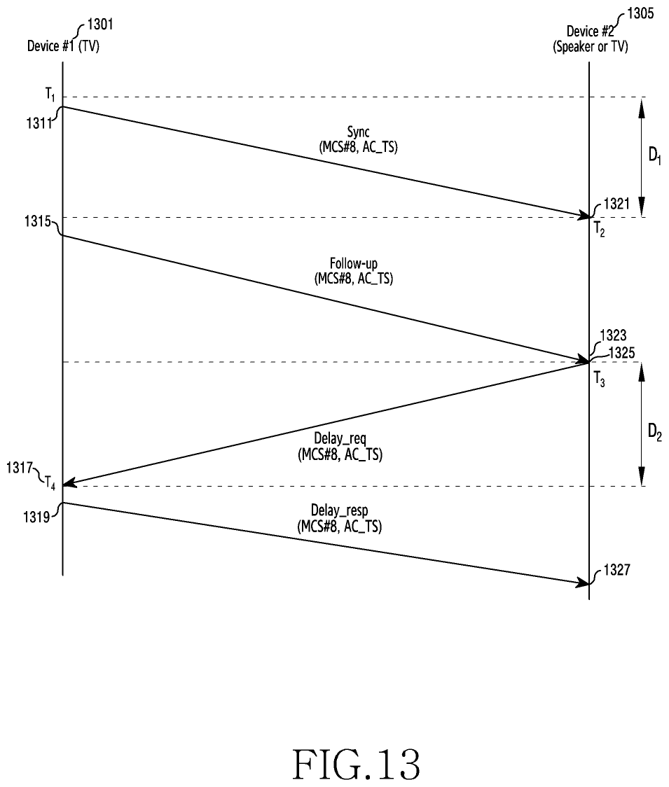

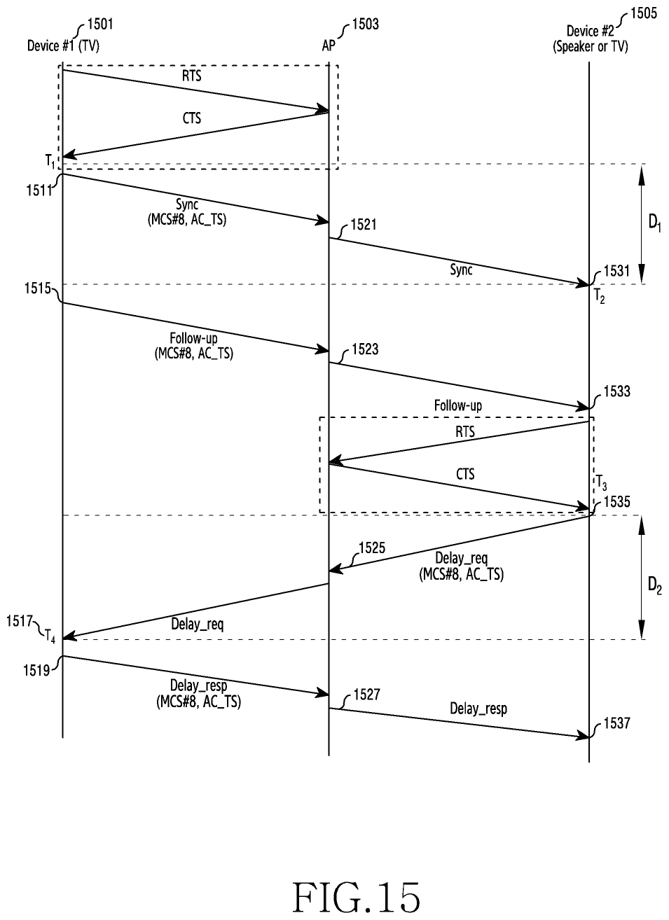

Next, device #1 1201 may transmit, to the AP 1203, a fourth message including information regarding the timepoint T₄ at which the third message was received at operation 1219. Although it is assumed in the illustration in FIG. 12 that an MCS corresponding to a fixed MCS index for preventing retransmission is also applied to the fourth message, and the highest priority (AC_TS) for securing transmission opportunities is configured therefor, the transmission delay of the fourth message in the PTP procedure may not be a factor affecting the occurrence of errors, and it is thus unnecessary to apply the fixed MCS index and the highest priority to the fourth message. The AP 1203 may transmit the received third message to device #2 1205 at operation 1227. Device #2 1205 may then acquire, through the fourth message, information regarding the timepoint T₄ at which device #1 1201 transmitted the third message 1237 or 1327 in FIG. 13 or 1537 in FIG. 15. Based on the previously stored information regarding T₃ and the information regarding T₄ acquired through the fourth message, device #2 1205 may acquire the offset (D2 value) between the timepoint T₄ at which device #1 1201 received the third message and the timepoint T₃ at which device #2 1205 transmitted the third message, by subtracting the T₃ value from the T₄ value.

Through the D1 value and D2 value acquired through the above operations, the symmetric delay value and the offset value may be acquired according to Equation 1 above.

FIG. 13 is a flowchart illustrating performing a PTP procedure to which schemes for improving errors are applied according to an embodiment of the disclosure. More specifically, the example of FIG. 13 may relate to a case where schemes for improving errors according to an embodiment of the disclosure are applied to an SW-based PTP procedure.

Referring to FIG. 13, device #1 1301 may transmit a first message for synchronization to device #2 1305 at timepoint T₁ at operation 1311. An MCS corresponding to a fixed MCS index for preventing retransmission is applied to the first message, and the highest priority (AC_TS) for securing transmission opportunities may be configured therefor. Accordingly, additional delays due to performing retransmissions and failed transmission opportunity acquisition are prevented.

Next, device #2 1305 may acquire and store the timepoint T₂ at which the first message is received at operation 1321.

Next, device #1 1301 may transmit, to device #2 1305, a second message including information regarding timepoint T₁ at which device #1 1301 transmitted the first message at operation 1315. Although it is assumed in the illustration in FIG. 13 that an MCS corresponding to a fixed MCS index for preventing retransmission is also applied to the second message, and the highest priority (AC_TS) for securing transmission opportunities is configured therefor, the transmission delay of the second message in the PTP procedure may not be a factor affecting the occurrence of errors, and it is thus unnecessary to apply the fixed MCS index and the highest priority to the second message.

Device #2 1305 may acquire, through the second message, information regarding the timepoint T₁ at which device #1 1301 transmitted the first message at operation 1323. Based on the previously stored information regarding T₂ and the information regarding T₁ acquired through the second message, device #2 1305 may acquire the offset (D1 value) between the timepoint T₁ at which device #1 1301 received the first message and the timepoint T₂ at which device #2 1305 received the first message, by subtracting the T₁ value from the T₂ value.

Subsequently, device #1 1301 may receive a third message from device #2 1305 at timepoint T₄, and may acquire and store the timepoint T₄ at which the third message is received at operation 1317 or at operation 1525 in FIG. 15. When transmitting the third message, device #2 1305 may apply an MCS corresponding to a fixed MCS index for preventing retransmission to the third message, and may configure the highest priority (AC_TS) for securing transmission opportunities at operation 1325. Accordingly, additional delays due to retransmission of the third message and a failure to secure transmission opportunities are prevented. Device #2 1305 may store information regarding the timepoint T₃ at which the third message was transmitted.

Next, device #1 1301 may transmit, to device #2 1305, a fourth message including information regarding the timepoint T₄ at which the third message was received at operation 1319 or at operation 1527 in FIG. 15. Although it is assumed in the illustration in FIG. 13 that an MCS corresponding to a fixed MCS index for preventing retransmission is also applied to the fourth message, and the highest priority (AC_TS) for securing transmission opportunities is configured therefor, the transmission delay of the fourth message in the PTP procedure may not be a factor affecting the occurrence of errors, and it is thus unnecessary to apply the fixed MCS index and the highest priority to the fourth message. Device #2 1305 may acquire, through the fourth message, information regarding the timepoint T₄ at which device #1 1301 received the third message. Based on the previously stored information regarding T₃ and the information regarding T₄ acquired through the fourth message, device #2 1305 may acquire the offset (D2 value) between the timepoint T₄ at which device #1 1301 received the third message and the timepoint T₃ at which device #2 1305 transmitted the third message, by subtracting the T₃ value from the T₄ value.

Through the D1 value and D2 value acquired through the above operations, the symmetric delay value and the offset value may be acquired according to Equation 1 above.

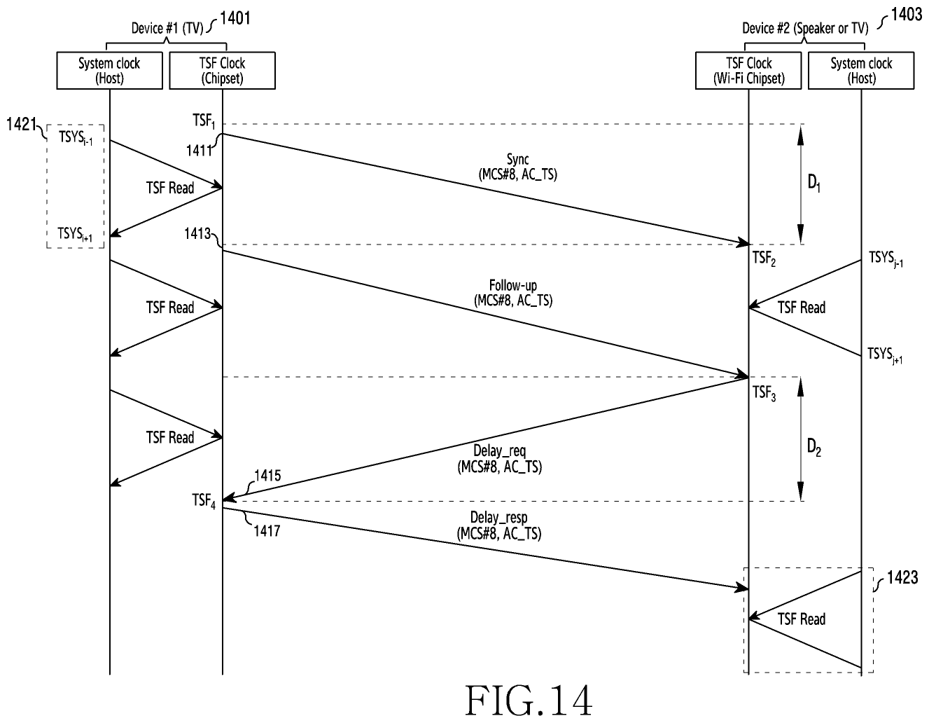

FIG. 14 is a flowchart illustrating performing a PTP procedure to which schemes for improving errors are applied according to an embodiment of the disclosure. More specifically, the example of FIG. 14 may relate to a case where schemes for improving errors according to an embodiment of the disclosure are applied to an HW-based PTP procedure.

Referring to FIG. 14, device #1 1401 may perform a TSF clock read operation 1421 to synchronize the TSF clock of device #1 1401 with the system clock of device #1 1401. As a result of performing the TSF clock read operation 1421, a TSF clock value corresponding to the timepoint at which the TSF clock read operation 1421 was performed may be acquired. In the case of FIG. 14, TSF clock value TSFᵢ may be acquired through the TSF clock read operation 1421 performed between timepoint TSYSᵢ₋₁ and timepoint TSYSᵢ₊₁. Device #1 1401 may repeatedly perform the TSF clock read operation 1421, and among the acquired TSF clock values corresponding to the repeatedly performed TSF clock read operations 1421, the TSF clock value acquired through the TSF clock reading that has the smallest interval between the timepoint TSYSᵢ₋₁ at which the TSF clock read operation 1421 of the system clock of device #1 1401 was initiated and the timepoint TSYSᵢ₊₁ at which the TSF clock read operation 1421 of the system clock was completed may be determined as the TSF clock value (TSF₁ in the case of FIG. 14) used in the synchronization procedure. The TSF clock value TSF₁ used in the synchronization procedure of FIG. 14 may be a value acquired according to the TSF clock read operation performed prior to the timepoint illustrated in FIG. 14.

Device #1 1401 may transmit a first message for synchronization to device #2 1403 at timepoint TSF₁, based on the TSF clock value synchronized with the system clock of device #1 1401 at operation 1411. An MCS corresponding to a fixed MCS index for preventing retransmission is applied to the first message, and the highest priority (AC_TS) for securing a transmission opportunity may be configured therefor. Additional delays due to performing retransmissions and failed transmission opportunity acquisition are prevented.

Device #2 1403 may receive the first message transmitted by device #1 1401 at timepoint TSF₂, and device #2 1403 may acquire and store the timepoint TSF₂ at which the first message was received.

Next, device #1 1401 may transmit a second message including information regarding the timepoint TSF₁ at which device #1 1401 transmitted the first message, to device #2 1403 at operation 1413. Although it is assumed in the illustration in FIG. 14 that an MCS corresponding to a fixed MCS index for preventing retransmission is also applied to the second message, and the highest priority (AC_TS) for securing transmission opportunities is configured therefor, the transmission delay of the second message in the PTP procedure may not be a factor affecting the occurrence of errors, and it is thus unnecessary to apply the fixed MCS index and the highest priority to the second message. The second message may be referred to as a “follow-up message.”

Device #2 1403 may acquire information regarding the timepoint TSF₁ at which device #1 1401 transmitted the first message, through the second message. Based on the previously stored information regarding TSF₂ and the information regarding TSF₁ acquired through the second message, device #2 1403 may acquire the offset value between the timepoint TSF₁ at which device #1 1401 transmitted the first message and the timepoint TSF₂ at which device #2 1403 received the first message, by subtracting the TSF₁ value from the TSF₂ value.

Thereafter, device #1 1401 may receive a third message from device #2 1403 at timepoint TSF₄ at operation 1415. When transmitting the third message, device #2 1403 may apply an MCS corresponding to a fixed MCS index for preventing retransmission to the third message, and may configure the highest priority (AC_TS) for securing transmission opportunities. Accordingly, additional delays due to retransmission of the third message and a failure to secure transmission opportunities are prevented. Device #2 1403 may store information regarding the timepoint T₃ at which the third message was transmitted. Device #2 1403 may acquire and store the timepoint TSF₃ at which device #2 1403 transmitted the third message. In addition, device #1 1401 may acquire and store the timepoint TSF₄ at which the third message was received.

Next, device #1 1401 may transmit a fourth message including information regarding the timepoint TSF₄ at which the third message was received, to device #2 1403 at operation 1417. Although it is assumed in the illustration in FIG. 12 that an MCS corresponding to a fixed MCS index for preventing retransmission is also applied to the fourth message, and the highest priority (AC_TS) for securing transmission opportunities is configured therefor, the transmission delay of the fourth message in the PTP procedure may not be a factor affecting the occurrence of errors, and it is thus unnecessary to apply the fixed MCS index and the highest priority to the fourth message. Device #2 1403 may acquire information regarding the timepoint TSF₄ at which device #1 1401 received the third message, through the fourth message. Based on the previously stored information regarding TSF₃ and the information regarding TSF₄ acquired through the fourth message, device #2 1403 may acquire the offset value between the timepoint TSF₄ at which device #1 1401 received the third message and the timepoint TSF₃ at which device #2 1403 transmitted the third message, by subtracting the TSF₃ value from the TSF₄ value.

Through the TSF₁ to TSF₄ values acquired through the above operations, the symmetric delay value and TSF offset value may be acquired according to Equation 2 above.

Based on the acquired symmetric delay value and offset value, synchronization between device #1 1401 and device #2 1403 may be accomplished. For example, the system clock of device #1 1401 and the system clock of device #2 1403 may be aligned.

In addition, assuming that the TSF clock value acquired through the TSF clock reading that has the smallest interval between the timepoint TSYSᵢ₋₁ at which the TSF clock read operation 1421 of the system clock of device #1 1401 is initiated and the timepoint TSYSᵢ₊₁ at which the TSF clock read operation 1421 of the system clock is completed is referred to as TSFₖ, the system clock offset delay of device #1 1401 after synchronization may be defined as in Equation 3 above.

In addition, assuming that the interval between the timepoint TSYSⱼ₋₁ at which the TSF clock read operation of the system clock of device #2 1403 is initiated and the timepoint TSYSⱼ₊₁ at which the TSF clock read operation of the system clock is completed is the smallest among the intervals between the initiation/completion timepoints of the repeatedly performed TSF clock read operations, and that the TSF clock value acquired in this regard is referred to as TSFᵢ, the system clock offset delay of device #2 1403 after synchronization may be defined as in Equation 4 above.

FIG. 15 is a flowchart illustrating performing a PTP procedure to which schemes for improving errors are applied according to an embodiment of the disclosure. More specifically, the example of FIG. 15 may relate to a case where schemes for improving errors according to an embodiment of the disclosure are applied to an SW-based PTP procedure.

Referring to FIG. 15, device #1 1501 may further perform an RTS/CTS procedure with the AP 1503 in order to prevent retransmission from being performed by reducing collision with other devices, prior to transmitting a first message for synchronization to the AP 1503 at timepoint T₁ at operation 1541.

Next, device #1 1501 may transmit a first message for synchronization to the AP 1503 at timepoint T₁ at operation 1511. An MCS corresponding to a fixed MCS index for preventing retransmission is applied to the first message, and the highest priority (AC_TS) for securing a transmission opportunity may be configured therefor. Accordingly, additional delays due to performing retransmissions and failed transmission opportunity acquisition are prevented.

Next, upon receiving the first message from device #1 1501, the AP 1503 may transmit the first message to device #2 1505 at operation 1521, and device #2 1505 may acquire and store the timepoint T₂ at which the first message is received at operation 1531.

Next, device #1 1501 may transmit, to the AP 1503, a second message including information regarding timepoint T₁ at which device #1 1501 transmitted the first message at operation 1515. The AP 1503 may transmit, to device #2 1505, a second message including information regarding timepoint T₁ at which device #1 1501 transmitted the first message at operation 1523. Although it is assumed in the illustration in FIG. 15 that an MCS corresponding to a fixed MCS index for preventing retransmission is also applied to the second message, and the highest priority (AC_TS) for securing transmission opportunities is configured therefor, the transmission delay of the second message in the PTP procedure may not be a factor affecting the occurrence of errors, and it is thus unnecessary to apply the fixed MCS index and the highest priority to the second message. Device #2 1505 may acquire, through the second message, information regarding the timepoint T₁ at which device #1 1501 transmitted the first message at operation 1533. Based on the previously stored information regarding T₂ and the information regarding T₁ acquired through the second message, device #2 1505 may acquire the offset (D1 value) between the timepoint T₁ at which device #1 1501 transmitted the first message and the timepoint T₂ at which device #2 1505 received the first message, by subtracting the T₁ value from the T₂ value.

Thereafter, device #1 1501 may receive a third message from the AP 1503 at timepoint T₄, and may acquire and store the timepoint T₄ at which the third message is received at operation 1517. Before device #2 1505 transmits the third message, device #2 1505 may further perform an RTS/CTS procedure with the AP 1503 in order to prevent retransmission from being performed by reducing collision with other devices at operation 1543. Thereafter, when transmitting the third message, device #2 1505 may apply an MCS corresponding to a fixed MCS index for preventing retransmission to the third message, and may configure the highest priority (AC_TS) for securing transmission opportunities at operation 1535. Accordingly, additional delays due to retransmission of the third message and a failure to secure transmission opportunities are prevented. Device #2 1505 may store information regarding the timepoint T₃ at which the third message was transmitted.

Next, device #1 1501 may transmit, to the AP 1503, a fourth message including information regarding the timepoint T₄ at which the third message was received at operation 1519. Although it is assumed in the illustration in FIG. 15 that an MCS corresponding to a fixed MCS index for preventing retransmission is also applied to the fourth message, and the highest priority (AC_TS) for securing transmission opportunities is configured therefor, the transmission delay of the fourth message in the PTP procedure may not be a factor affecting the occurrence of errors, and it is thus unnecessary to apply the fixed MCS index and the highest priority to the fourth message. The AP 1503 may transmit the received third message to device #2 1505. Device #2 1505 may acquire, through the fourth message, information regarding the timepoint T₄ at which device #1 1501 received the third message. Based on the previously stored information regarding T₃ and the information regarding T₄ acquired through the fourth message, device #2 1505 may acquire the offset (D2 value) between the timepoint T₄ at which device #1 1501 received the third message and the timepoint T₃ at which device #2 1505 transmitted the third message, by subtracting the T₃ value from the T₄ value.

Through the D1 value and D2 value acquired through the above operations, the symmetric delay value and the offset value may be acquired according to Equation 1 above.

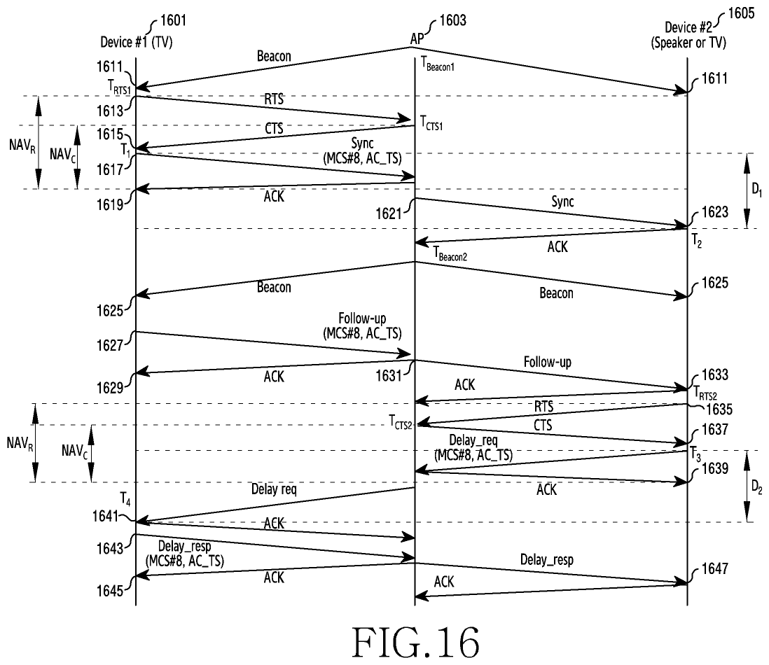

FIG. 16 is a flowchart illustrating performing a PTP procedure to which schemes for improving errors are applied according to an embodiment of the disclosure. More specifically, the example of FIG. 16 may relate to a case where schemes for improving errors according to an embodiment of the disclosure are applied to an SW-based PTP procedure.

Referring to FIG. 16, the AP 1603 may transmit a beacon message to device #1 1601 and device #2 1605 at operation 1611.

Device #1 1601 (transmitting device) may further perform an RTS/CTS procedure with the AP 1603 in order to prevent retransmission from being performed by reducing collision with other devices, prior to transmitting a first message for synchronization to the AP 1603 at timepoint T₁ at operations 1613, 1615.

Next, device #1 1601 may transmit a first message for synchronization to the AP 1603 at timepoint T₁ at operation 1611. An MCS corresponding to a fixed MCS index for preventing retransmission is applied to the first message, and the highest priority (AC_TS) for securing a transmission opportunity may be configured therefor. Accordingly, additional delays due to performing retransmissions and failed transmission opportunity acquisition are prevented.

Thereafter, device #1 1601 may receive an ACK regarding the first message from the AP 1603 at operation 1617. Device #1 1601 may acquire the difference (NAV_{RTS1}) between the timepoint at which device #1 1601 transmitted the RTS and the timepoint at which device #1 1601 received the ACK regarding the first message, and the difference (NAV_{CTS1}) between the timepoint at which the AP 1603 transmitted the CTS and the timepoint at which device #1 1601 received the ACK regarding the first message, and NAV_{RTS1} may be used to calculate the offset for synchronization between device #1 1601 and device #2 1605.

Next, upon receiving the first message from device #1 1601, the AP 1603 may transmit the first message to device #2 1605 at operation 1621, and device #2 1605 may acquire and store the timepoint T₂ at which the first message is received, and may transmit an ACK to the AP 1603 at operation 1623.

Thereafter, the AP 1603 may transmit a beacon message to device #1 1601 and device #2 1605 at operation 1625.

Next, device #1 1601 may transmit, to the AP 1603, a second message including information regarding timepoint T₁ at which device #1 1601 transmitted the first message at operation 1627, and may receive an ACK regarding the second message from the AP 1603 at operation 1629.

The AP 1603 may transmit, to device #2 1605, a second message including information regarding timepoint T₁ at which device #1 1601 transmitted the first message at operation 1631. Although it is assumed in the illustration in FIG. 16 that an MCS corresponding to a fixed MCS index for preventing retransmission is also applied to the second message, and the highest priority (AC_TS) for securing transmission opportunities is configured therefor, the transmission delay of the second message in the PTP procedure may not be a factor affecting the occurrence of errors, and it is thus unnecessary to apply the fixed MCS index and the highest priority to the second message. Device #2 1605 may acquire, through the second message, information regarding the timepoint T₁ at which device #1 1601 transmitted the first message, and device #2 1605 may transmit an ACK regarding the second message at operation 1633. Based on the previously stored information regarding T₂ and the information regarding T₁ acquired through the second message, device #2 1605 may acquire the offset (D1 value) between the timepoint T₁ at which device #1 1601 transmitted the first message and the timepoint T₂ at which device #2 1605 received the first message, by subtracting the T₁ value from the T₂ value.

Thereafter, device #1 1601 may receive a third message from the AP 1603 at timepoint T₄, and may acquire and store the timepoint T₄ at which the third message is received at operation 1641. Before device #2 1605 transmits the third message, device #2 1505 may further perform an RTS/CTS procedure with the AP 1603 in order to prevent retransmission from being performed by reducing collision with other devices at operations 1633, 1635. Thereafter, when transmitting the third message, device #2 1605 may apply an MCS corresponding to a fixed MCS index for preventing retransmission to the third message, may configure the highest priority (AC_TS) for securing transmission opportunities, may transmit the third message to the AP 1603 at operation 1637, and may receive an ACK regarding the third message from the AP 1603 at operation 1639. Device #2 1605 may acquire the difference (NAV_{RTS2}) between the timepoint at which device #2 1605 transmitted the RTS and the timepoint at which device #2 1605 received the ACK regarding the third message from the AP 1603, and the difference (NAV_{CTS2}) between the timepoint at which the AP 1603 transmitted the CTS and the timepoint at which device #2 1605 received the ACK regarding the third message, and NAV_{RTS2} may be used to calculate the offset for synchronization between device #1 1601 and device #2 1605.

Since both NAV_{RTS1} and NAV_{RTS2} are acquired at the corresponding timepoint, offset calculation through NAV_{RTS1} and NAV_{RTS2} may be defined as in Equation 5 below:

$$Offset : {o}_{NAV} = \frac{{NAV}_{RTS 1} - {NAV}_{RTS 2}}{2} \qquad Equation 5$$

In addition, device #2 1605 may store information regarding the timepoint T₃ at which the third message was transmitted.

Next, device #1 1601 may transmit, to the AP 1603, a fourth message including information regarding the timepoint T₄ at which the third message was received at operation 1643, and may receive an ACK regarding the same from the AP 1603 at operation 1645. Although it is assumed in the illustration in FIG. 16 that an MCS corresponding to a fixed MCS index for preventing retransmission is also applied to the fourth message, and the highest priority (AC_TS) for securing transmission opportunities is configured therefor, the transmission delay of the fourth message in the PTP procedure may not be a factor affecting the occurrence of errors, and it is thus unnecessary to apply the fixed MCS index and the highest priority to the fourth message.

The AP 1603 may transmit the received third message to device #2 1605, and may receive an ACK regarding the same from device #2 1605. Device #2 1605 may acquire, through the fourth message, information regarding the timepoint T₄ at which device #1 1601 received the third message at operation 1647. Based on the previously stored information regarding T₃ and the information regarding T₄ acquired through the fourth message, device #2 1605 may acquire the offset (D2 value) between the timepoint T₄ at which device #1 1601 received the third message and the timepoint T₃ at which device #2 1605 transmitted the third message, by subtracting the T₃ value from the T₄ value.

Through the D1 value and D2 value acquired through the above operations, the symmetric delay value and the offset value may be acquired according to Equation 1 above.

In the case of the method in FIG. 16, values according to Equation 1 or values according to Equation 5 may be used for synchronization between devices. Alternatively, for synchronization between devices, values according to Equation 1 and values according to Equation 5 may be used together and may be averaged, for example.

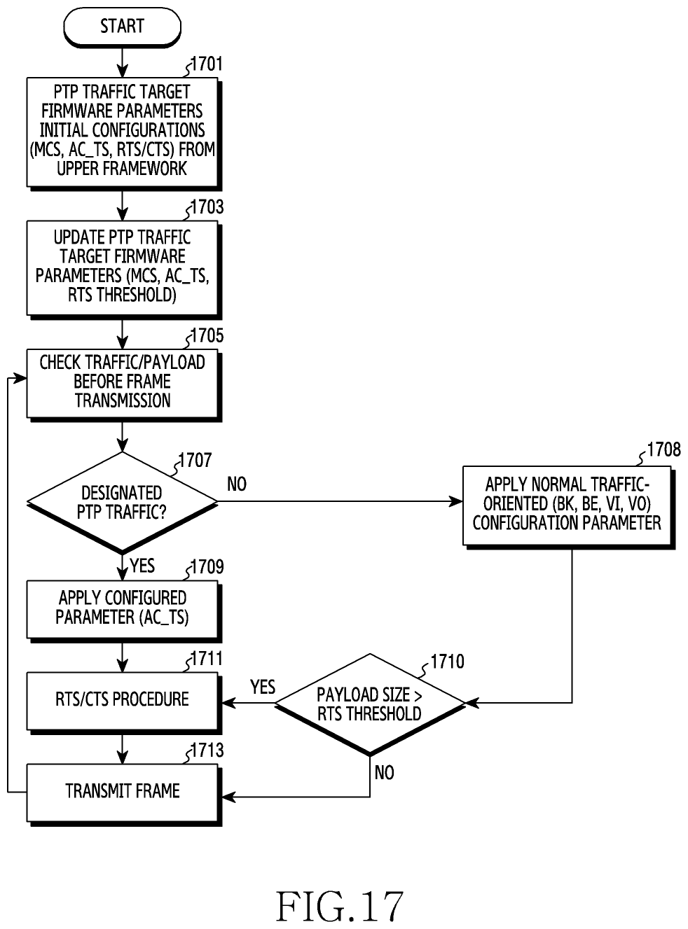

FIG. 17 is a flowchart illustrating performing a PTP procedure to which schemes for improving errors are applied according to an embodiment of the disclosure. More specifically, FIG. 17 may be an example regarding the operation sequence from the perspective of a device for transmitting PTP-related messages.

First, the device (the lower layer of the device) may receive an initial configuration regarding firmware parameters that may be applied to PTP traffic targets (PTP messages/packets) from the upper layer at operation 1701. Next, the device may update preconfigured PTP traffic target firmware parameters with the PTP traffic target firmware parameters received from the upper layer at operation 1703.

Next, in case that a frame (message/packet) to be transmitted occurs, the device can identify the traffic/payload of the corresponding frame at operation 1705.

In case that the identification in 1705 confirms at operation 1707 that the traffic of the frame is the designated PTP traffic, the parameters (AC_TS or the like) configured for PTP traffic may be applied at operation 1709. Thereafter, after performing the RTS/CTS procedure at operation 1711, the frame may be transmitted at operation 1713.

In case that the identification in 1705 confirms that the traffic of the frame is not the designated PTP traffic, the device may apply parameters configured for normal traffic to the frame that occurred at operation 1708. Thereafter, the device may determine whether the payload size of the frame is greater than the threshold for RTS transmission at operation 1710. If the payload size of the frame is greater than the threshold for RTS transmission, the device may perform the RTS/CTS procedure at operation 1711 and may then transmit the frame at operation 1713. If the payload size of the frame is smaller than the threshold for RTS transmission, the frame may be transmitted without performing the RTS/CTS procedure at operation 1713.

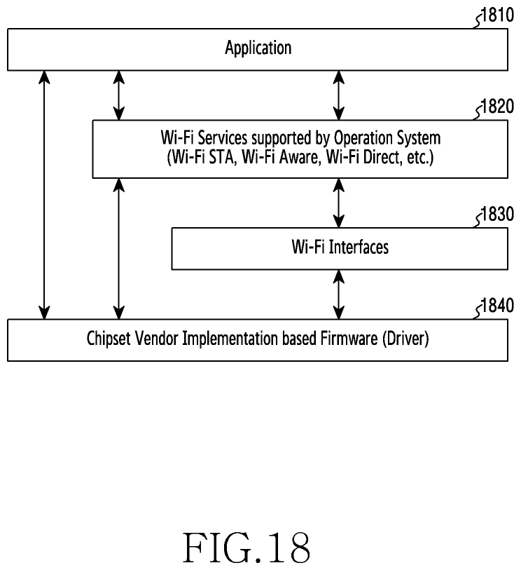

FIG. 18 is a diagram illustrating protocol layers within a device in which commands for configurations related to schemes for improving errors in a PTP procedure may be transmitted/received with each other according to an embodiment of the disclosure.

Referring to FIG. 18, commands for configurations related to schemes for improving errors in a PTP procedure according to an embodiment of the disclosure are as follows:

(1) Commands for PTP traffic target parameter configuration control: may include commands for configuring a fixed MCS to be used, or configuring an MCS having a value within a limited rate adaptation MCS maximum value to be applied, commands for configuring the highest priority for PTP packets/messages, and commands for instructing to perform RTS/CTS with regard to PTP packets/messages.

(2) New access category (AC) parameter configuration update command: this may be a command used to update existing configurations with configurations provided through a PTP traffic target parameter configuration control.

(3) TSF-related firmware-level commands:

For example, commands, such as Get_TSF_value (interface), Get_FTM_values (interface), Get_NAV_value (interface), Write_TSF_value (interface, packet), Read_TSF_value (interface, packet) may be defined.

The aforementioned commands may be provided directly from the topmost layer 1810 to the bottommost layer 1840, may be provided from the topmost layer 1810 to the bottommost layer 1840 through the next highest layer 1820, or may be provided from the topmost layer 1810 to the bottommost layer 1840 through the next highest layer 1820 and the next bottommost layer 1830.

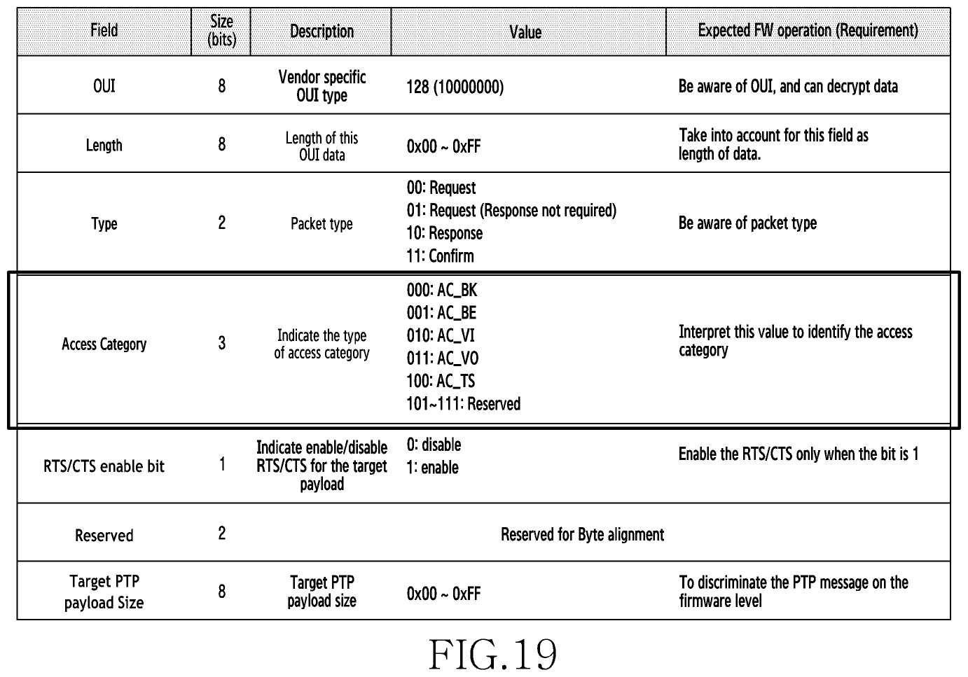

FIG. 19 is a diagram illustrating a command for controlling parameter configurations for PTP traffic according to an embodiment of the disclosure.

Referring to FIG. 19, the command may include a field for configuring a fixed MCS to be used, for configuring an MCS having a value within a limited rate adaptation MCS maximum value to be applied, a field (access category) for configuring the highest priority for a PTP packet/message, and a field (RTS/CTS enable bit) for instructing to perform RTS/CTS with regard to a PTP packet/message.

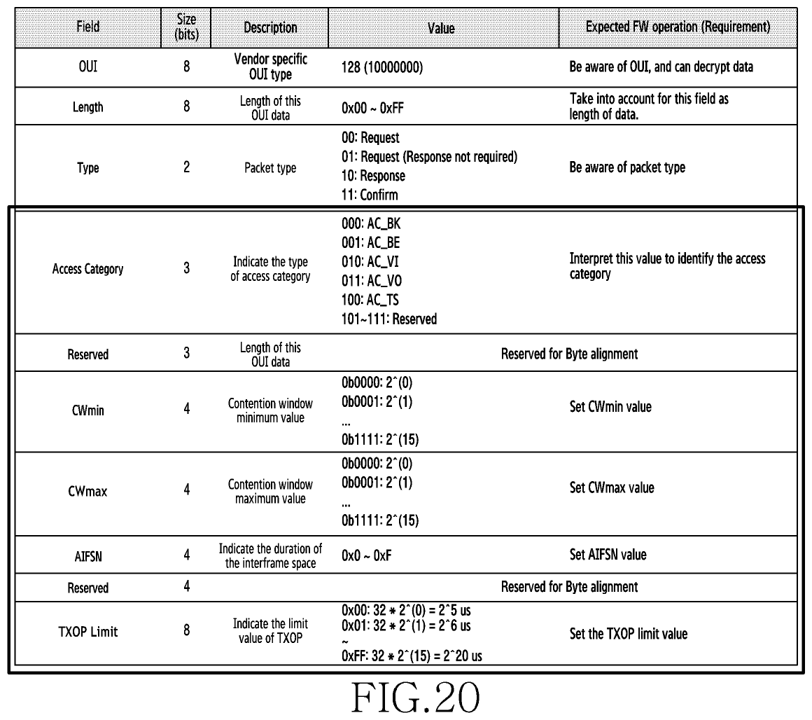

FIG. 20 is a diagram illustrating a command for updating AC parameter configurations according to an embodiment of the disclosure.

Referring to FIG. 20, the backoff time, which is the waiting time before starting frame transmission after the channel waits for a distributed inter-frame space (DIFS) or extended inter-frame space (EIFS), may be defined as “Random( )×SlotTime”.

Random( ) has an integer value between [0, CW], wherein CW may have an integer value between CWmin and CWmax, and the CW value may increase from the initial CWmin value (usually 2\hat{ }5−1=31) to the CWmax value (usually 2\hat{ }10−1=1023) obtained by subtracting 1 from the next power of 2.

In addition, in FIG. 20, the TXOP limit field represents a period during which the frame transmission time of any one device is forcibly limited. In case that the size of the data frame that the transmitting device intends to transmit exceeds the TXOP limit value, the device may fragment the frame into multiple smaller frames and then transmit the same within a range that does not exceed the TXOP limit value.

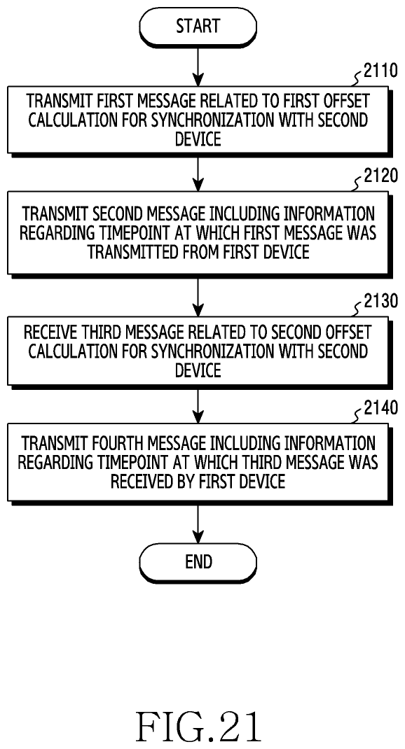

FIG. 21 is a diagram illustrating a method performed by a first device according to an embodiment of the disclosure.

Referring FIG. 21, first, the first device may transmit a first message related to the calculation of a first offset for synchronization with a second device at operation 2110.

Next, the first device may transmit a second message including information regarding the timepoint at which the first message was transmitted from the first device at operation 2120.

Thereafter, the first device may receive a third message related to the calculation of a second offset for synchronization with the second device at operation 2130.

Next, the first device may transmit a fourth message including information regarding the timepoint at which the third message was received by the first device at operation 2140.

With regard to the first message and the third message: an MCS configuration corresponding to one fixed MCS index among available candidate modulation and coding scheme (MCS) index values may be applied, or any one MCS configuration within an MCS subset configured by MCS configurations corresponding to at least one MCS index equal to or lower than a specific MCS index among available candidate modulation and coding scheme (MCS) index values may be applied, and the highest priority among priorities related to securing transmission opportunities may be applied.

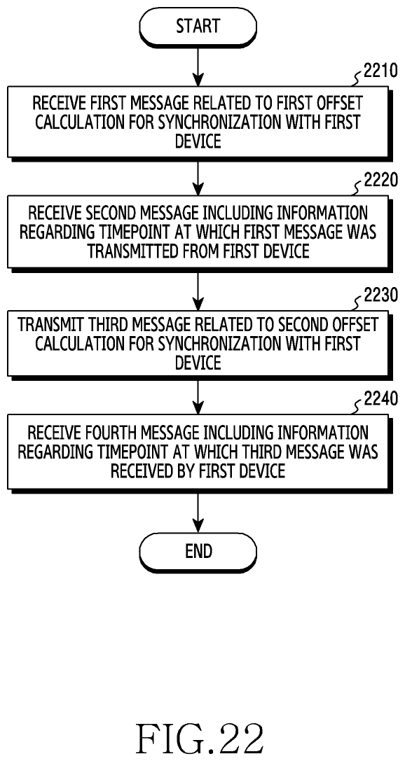

FIG. 22 is a diagram illustrating a method performed by a second device according to an embodiment of the disclosure.

Referring FIG. 22, the second device may receive a first message related to the calculation of a first offset for synchronization with a first device at operation 2210.

Next, the second device may receive a second message including information regarding the timepoint at which the first message was transmitted from the first device at operation 2220.

Next, the second device may transmit a third message related to the calculation of a second offset for synchronization with the first device at operation 2230.

Thereafter, the second device may receive a fourth message including information regarding the timepoint at which the third message was received by the first device at operation 2240.

With regard to the first message and the third message: an MCS configuration corresponding to one fixed MCS index among available candidate modulation and coding scheme (MCS) index values may be applied, or any one MCS configuration within an MCS subset configured by MCS configurations corresponding to at least one MCS index equal to or lower than a specific MCS index among available candidate modulation and coding scheme (MCS) index values may be applied, and the highest priority among priorities related to securing transmission opportunities may be applied.

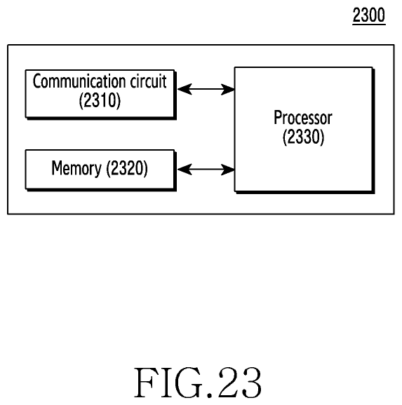

FIG. 23 is a block diagram of an external electronic device according to an embodiment of the disclosure.

Referring to FIG. 23, an external electronic device 2300 (e.g., the electronic device 101 in FIG. 1) may include a communication circuit 2310 (e.g., the wireless communication module 192 in FIG. 1) that transmits/receives signals with the external electronic device by using one or more antennas, memory 2320 (e.g., the memory 130 in FIG. 1) that stores instructions for the operation of the external electronic device 2300, and a processor 2330 (e.g., the processor 120 in FIG. 1) that may be implemented as one or more single-core processors or one or more multi-core processors.

The communication circuit 2310 may include various circuit structures used for modulation and/or demodulation of signals within the external electronic device 2300. For example, the communication circuit 2310 may modulate a baseband signal into a radio frequency (RF) band signal to be output through an antenna (not illustrated), or may demodulate an RF band signal received through the antenna into a baseband signal and transmit the same to the processor 2330.

The communication circuit 2310 may support at least one of various wired/wireless communication methods. For example, the communication circuit 2310 may be in the form of a chipset, or may be a sticker/barcode (e.g., a sticker including an NFC tag) that includes information necessary for communication. The communication circuit 2310 may support, for example, cellular communication, wireless fidelity (Wi-Fi), Wi-Fi Direct, Bluetooth, ultra-wideband (UWB), or near field communication (NFC).

Various types of data, such as applications, programs like instructions, and files, may be installed and stored in the memory 2320. The processor 2330 may access and use data stored in the memory 2320, or may store new data in the memory 2320. In an embodiment of the disclosure, programs and data for transmitting/receiving audio data may be installed and stored in the memory 2320.

The processor 2330 may control the overall operation of the external electronic device 2300. In an embodiment of the disclosure, the processor 2330 may control other components included in the external electronic device 2300 such that the external electronic device 2300 performs audio alignment. For example, the processor 2330 may execute programs, instructions, etc. stored in the memory 2320, may read files stored in the memory 2320, or may store new files in the memory 2320.

In one embodiment of the disclosure, the description that the processor 2330 performs an operation may mean that the processor 2330 directly performs the operation, or may include cases in which the processor 2330 performing the operation by controlling other components, for example, the communication circuit 2310.

In one embodiment of the disclosure, the processor 2330 may perform audio alignment by executing a program stored in the memory 2320. The instructions stored in the memory 2320, when executed by the processor 2330, may cause the external electronic device 2300 to perform at least: an operation of discovering an electronic device included in a neighbor awareness networking (NAN) cluster by performing NAN service discovery in a discovery window (DW), an operation of establishing an NAN data path (NDP) session with an electronic device, an operation of receiving a synchronization signal in the DW from the electronic device, thereby acquiring a timing synchronization function (TSF) value, an operation of performing an fine time measurement (FTM) procedure with the electronic device, thereby acquiring an FTM value, and an operation of performing playback time alignment of an audio signal based on the TSF value and the FTM value.

In an embodiment of the disclosure, the instructions stored in the memory 2320, when executed by the processor 2330, may cause the external electronic device 2300 to perform, by the framework of the external electronic device an operation of acquiring a local time, an operation of directly receiving a TSF value and an FTM value from a Wi-Fi driver or Wi-Fi firmware through a first interface, an operation of acquiring a new environmental stress cracking resistance (ESCR) value based on the local time and the TSF value, an operation of acquiring an average latency based on the FTM value, an operation of acquiring a present time stamp (PTS) value based on the new ESCR value and the average latency, and an operation of determining a playback time of an audio signal based on the PTS.

In an embodiment of the disclosure, the instructions stored in the memory 2320, when executed by the processor 2330, may cause the external electronic device 2300 to perform, by the framework of the external electronic device an operation of acquiring a local time, an operation of directly receiving a TSF value and an FTM value from a Wi-Fi driver or Wi-Fi firmware through a first interface, an operation of calibrating the current clock reference, and an operation of delivering the TSF value, the FTM value, and the updated current time to a player. In addition, the instructions stored in the memory 2320, when executed by the processor 2330, may cause the external electronic device 2300 to perform, by the player of the external electronic device 2300 an operation of receiving the TSF value, the FTM value, and the updated current time from the framework, an operation of acquiring a new ESCR value based on the updated current time and the TSF value, an operation of acquiring an average latency based on the FTM value, an operation of acquiring a present time stamp (PTS) value based on the new ESCR value and the average latency, and an operation of determining the playback time of an audio signal based on the PTS.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method of a first device, the method comprising:
transmitting a first message related to calculation of a first offset for synchronization with a second device;
transmitting a second message comprising information regarding a timepoint at which the first message was transmitted from the first device;
receiving a third message related to calculation of a second offset for synchronization with the second device; and
transmitting a fourth message comprising information regarding a timepoint at which the third message was received by the first device,
wherein, with regard to the first message and the third message:
an MCS configuration corresponding to one fixed modulation and coding scheme (MCS) index among available candidate MCS index values is applied, or one MCS configuration within an MCS subset configured by MCS configurations corresponding to at least one MCS index equal to or lower than an MCS index among the available candidate MCS index values is applied, and
the highest priority among priorities related to securing transmission opportunities is applied.

2. The method of claim 1, wherein request-to-send (RTS) transmission and clear-to-send (CTS) reception are configured to be performed prior to transmission of the first message.

3. The method of claim 1, wherein the priorities are configured such that, the higher the priority, the shorter the delay time until the next transmission opportunity securing operation timepoint in case that no transmission opportunity is secured.

4. The method of claim 1,
wherein the first offset is a difference between a timepoint at which the first message was transmitted from the first device and a timepoint at which the first message was received by the second device, and
wherein the second offset is a difference between a timepoint at which the third message was received by the first device and a timepoint at which the third message was transmitted by the second device.

5. The method of claim 1, wherein, with regard to the second message and the fourth message, one of the available candidate MCS index values is applied, and one of priorities related to securing transmission opportunities is applied.

6. A method of a second device, the method comprising:
receiving a first message related to calculation of a first offset for synchronization with a first device;
receiving a second message comprising information regarding a timepoint at which the first message was transmitted from the first device;
transmitting a third message related to calculation of a second offset for synchronization with the first device; and
receiving a fourth message comprising information regarding a timepoint at which the third message was received by the first device,
wherein, with regard to the first message and the third message:
an MCS configuration corresponding to one fixed modulation and coding scheme (MCS) index among available candidate MCS index values is applied, or one MCS configuration within an MCS subset configured by MCS configurations corresponding to at least one MCS index equal to or lower than an MCS index among the available candidate MCS index values is applied, and
the highest priority among priorities related to securing transmission opportunities is applied.

7. The method of claim 6, wherein request-to-send (RTS) transmission and clear-to-send (CTS) reception are configured to be performed prior to transmission of the third message.

8. The method of claim 6, wherein the priorities are configured such that, the higher the priority, the shorter the delay time until the next transmission opportunity securing operation timepoint in case that no transmission opportunity is secured.

9. The method of claim 6,
wherein the first offset is a difference between a timepoint at which the first message was transmitted from the first device and a timepoint at which the first message was received by the second device, and
wherein the second offset is a difference between a timepoint at which the third message was received by the first device and a timepoint at which the third message was transmitted by the second device.

10. The method of claim 6, wherein, with regard to the second message and the fourth message, one of the available candidate MCS index values is applied, and one of priorities related to securing transmission opportunities is applied.

11. A first device comprising:
a transceiver; and
a controller coupled with the transceiver,
wherein the controller is configured to:
transmit a first message related to calculation of a first offset for synchronization with a second device,
transmit a second message comprising information regarding a timepoint at which the first message was transmitted from the first device,
receive a third message related to calculation of a second offset for synchronization with the second device, and
transmit a fourth message comprising information regarding a timepoint at which the third message was received by the first device, and
wherein, with regard to the first message and the third message:
an MCS configuration corresponding to one fixed modulation and coding scheme (MCS) index among available candidate MCS index values is applied, or one MCS configuration within an MCS subset configured by MCS configurations corresponding to at least one MCS index equal to or lower than an MCS index among the available candidate MCS index values is applied, and
the highest priority among priorities related to securing transmission opportunities is applied.

12. The first device of claim 11, wherein request-to-send (RTS) transmission and clear-to-send (CTS) reception are configured to be performed prior to transmission of the first message.

13. The first device of claim 11, wherein the priorities are configured such that, the higher the priority, the shorter the delay time until the next transmission opportunity securing operation timepoint in case that no transmission opportunity is secured.

14. The first device of claim 11,
wherein the first offset is a difference between a timepoint at which the first message was transmitted from the first device and a timepoint at which the first message was received by the second device, and
wherein the second offset is a difference between a timepoint at which the third message was received by the first device and a timepoint at which the third message was transmitted by the second device.

15. The first device of claim 11, wherein, with regard to the second message and the fourth message, one of the available candidate MCS index values is applied, and one of priorities related to securing transmission opportunities is applied.

16. A second device comprising:
a transceiver; and
a controller coupled with the transceiver,
wherein the controller is configured to:
receive a first message related to calculation of a first offset for synchronization with a first device,
receive a second message comprising information regarding a timepoint at which the first message was transmitted from the first device,
transmit a third message related to calculation of a second offset for synchronization with the first device, and
receive a fourth message comprising information regarding a timepoint at which the third message was received by the first device, and
wherein, with regard to the first message and the third message:
an MCS configuration corresponding to one fixed modulation and coding scheme (MCS) index among available candidate MCS index values is applied, or one MCS configuration within an MCS subset configured by MCS configurations corresponding to at least one MCS index equal to or lower than an MCS index among the available candidate MCS index values is applied, and
the highest priority among priorities related to securing transmission opportunities is applied.

17. The second device of claim 16, wherein request-to-send (RTS) transmission and clear-to-send (CTS) reception are configured to be performed prior to transmission of the third message.

18. The second device of claim 16, wherein the priorities are configured such that, the higher the priority, the shorter the delay time until the next transmission opportunity securing operation timepoint in case that no transmission opportunity is secured.

19. The second device of claim 16,
wherein the first offset is a difference between a timepoint at which the first message was transmitted from the first device and a timepoint at which the first message was received by the second device, and
wherein the second offset is a difference between a timepoint at which the third message was received by the first device and a timepoint at which the third message was transmitted by the second device.

20. The second device of claim 16, wherein, with regard to the second message and the fourth message, one of the available candidate MCS index values is applied, and one of priorities related to securing transmission opportunities is applied.
